(19) United States
(12) Patent Application Publication
(10) Pub. No.: US 2026/0176778 A1
(43) Pub. Date: Jun. 25, 2026

(54) MEMBRANE ELECTRODE ASSEMBLY, METHOD FOR PRODUCING HYDROGEN, AND HYDROGEN PRODUCTION SYSTEM

(71) Applicant: FUJIFILM Corporation, Tokyo (JP)

(72) Inventors: Toshihiko YAWATA, Kanagawa (JP); Shin OZAWA, Kanagawa (JP); Toshihiro KAMADA, Kanagawa (JP); Naoya ISHIDA, Kanagawa (JP)

(73) Assignee: FUJIFILM Corporation, Tokyo (JP)

(21) Appl. No.: 19/545,079

(22) Filed: Feb. 20, 2026

Related U.S. Application Data
(63) Continuation of application No. PCT/JP2024/033929, filed on Sep. 24, 2024.

(30) Foreign Application Priority Data
Sep. 25, 2023 (JP) 2023-161730

(51) Int. Cl. C25B 9/23; C25B 1/04; C25B 11/052; C25B 13/08

(52) U.S. Cl. CPC C25B 9/23; C25B 1/04; C25B 11/052; C25B 13/08

(57) ABSTRACT

Provided are a membrane electrode assembly having a structure in which a cathode catalyst layer, a hydroxide ion-conductive membrane, and an anode catalyst layer are laminated in this order, in which a tensile strength (a) and a breaking elongation (b) of a water-swollen body of a polymer contained in the cathode catalyst layer and/or the anode catalyst layer and a tensile strength (c) and a breaking elongation (d) of a water-swollen body of a hydroxide ion-conductive polymer constituting the hydroxide ion-conductive membrane satisfy the following relationships (Ri) and (Rii), a method for producing hydrogen, and a hydrogen production system.

$$Tensile strength ( a ) > tensile strength ( c ) \qquad ( Ri )$$

$$Breaking elongation ( b ) > breaking elongation ( d ) \qquad ( Rii )$$

### CROSS-REFERENCE TO RELATED APPLICATIONS

This application is a Continuation of PCT International Application No. PCT/JP2024/033929 filed on Sep. 24, 2024, which claims priority under 35 U.S.C. § 119 (a) to Japanese Patent Application No. 2023-161730 filed in Japan on Sep. 25, 2023. Each of the above applications is hereby expressly incorporated by reference, in its entirety, into the present application.

### BACKGROUND OF THE INVENTION

### 1. Field of the Invention

The present invention relates to a membrane electrode assembly, a method for producing hydrogen, and a hydrogen production system.

### 2. Description of the Related Art

Hydrogen is a clean energy that does not emit carbon dioxide, and is used, for example, as a fuel for a fuel cell vehicle or a home fuel cell. As a method for producing hydrogen, electrolysis of water (water electrolysis) is known. In a case where water electrolysis is performed using, as a power source, a power generation system that uses renewable energy, hydrogen can be produced without emitting carbon dioxide, whereby hydrogen has been attracting increasing attention as a fundamental energy source for a sustainable society.

As an electrolysis technology that has been put into practical use, alkaline water electrolysis (AWE) using a high concentration of an alkali aqueous solution as an electrolyte is known. In the alkaline water electrolysis, a separator (diaphragm) having gas barrier properties is disposed between the cathode and the anode to prevent the bubble-like hydrogen (2H₂O+2e⁻→H₂+2OH⁻) generated at the cathode from moving to the anode side and to prevent the bubble-like oxygen (4OH⁻→O₂+2H₂O+4e⁻) generated at the anode from moving to the cathode side. As the separator, an anion exchange membrane-type water electrolysis (AEMWE) using an anion exchange membrane that enhances conduction (movement) of OH⁻ (hydroxide ion) from the cathode side to the anode side has also been proposed. In the AEMWE, hydroxide ions can be conducted with high efficiency from the cathode side to the anode side even without using a high concentration of an alkali aqueous solution as an electrolyte.

The electrode (anode catalyst layer and cathode catalyst layer) of the AEMWE is generally formed by mixing a catalyst in which a noble metal, a metal oxide, or the like is supported on a carrier such as carbon as necessary, an anionic ionomer that functions as a binder and also functions as an ion conductor, and a liquid medium, applying the mixture onto a conductive substrate (gas diffusion layer) having gas permeability and electron conductivity, and drying the coating film to remove the liquid medium. Next, an anion exchange membrane (hydroxide ion-conductive membrane) including a polymer having hydroxide ion conductivity is interposed between the formed anode catalyst layer and the formed cathode catalyst layer, and the anion exchange membrane is joined to the anode catalyst layer and the cathode catalyst layer by thermocompression bonding in a pressurized state to obtain a membrane electrode assembly (MEA) for AEMWE. For example, JP2023-104047A describes the following membrane electrode assembly.

A membrane electrode assembly used in a water electrolysis apparatus, the membrane electrode assembly including electrolyte membrane consisting of an anion exchange membrane, catalyst layers disposed on both the electrolyte membrane, and conductive substrates each laminated on a surface of the catalyst layer opposite to the surface facing the electrolyte layer, in which the catalyst layer includes a catalyst and an anionic ionomer, at least a part of the anionic ionomer is in contact with the electrolyte membrane in a state of having penetrated into the electrolyte membrane, and the membrane electrode assembly has a mixed region in which the anionic ionomer and the electrolyte membrane are mixed in the vicinity of a boundary between the catalyst layer and the electrolyte membrane.

According to the technology disclosed in JP2023-104047A, the adhesion between the electrolyte membrane and the catalyst layer is increased, and the movement resistance of hydroxide ions at the interface between the electrolyte membrane and the catalyst layer can be reduced, and as a result, it is considered that the resistance of the membrane electrode assembly can be reduced.

### SUMMARY OF THE INVENTION

In the MEA, low gas permeability and low ion resistance are required as basic characteristics of the diaphragm.

A solar power generation system that is widely used as a power generation system using renewable energy operates during the day and does not operate at night when the sun sets. That is, in a case where water electrolysis is performed using the solar power generation system as a power source, a time period during which power is supplied and a time period during which power is not supplied occur. In addition, the amount of supplied power increases or decreases depending on the weather even during the time period during which power is supplied. This tendency for the output to fluctuate is also common, to a considerable extent, to other power generation systems using renewable energy. Therefore, in a case where water electrolysis is performed using, as a power source, a power generation system using renewable energy to produce hydrogen, it is necessary to increase or decrease the amount of water to be supplied in accordance with the amount of supplied power, or to stop the supply of water during the time period during which power is not supplied.

As a result of repeated studies, the present inventors have found that, particularly in a case where the supply of water is stopped, the amount of water permeated into the MEA is reduced, and contraction of the hydroxide ion-conductive membrane composed of a polymer having a group with high hydrophilicity occurs, and in a case where the hydroxide ion-conductive membrane contracts, the interface between the hydroxide ion-conductive membrane and the anode catalyst layer and/or the cathode catalyst layer is likely to be peeled off (adhesiveness is reduced). The peeling of the interface causes a decrease in the efficiency of hydrogen production, such as hindering the movement of hydroxide ions generated in the cathode catalyst layer to the anode catalyst layer side.

An object of the present invention is to provide a membrane electrode assembly having low gas permeability and low ion resistance and capable of sufficiently maintaining a low resistance even in a case where on/off switching of energization or liquid supply is repeated, a method for producing hydrogen and a hydrogen production system, each using the membrane electrode assembly.

The above-described problems of the invention were solved by the following means.

[1]

A membrane electrode assembly having a structure in which a cathode catalyst layer, a hydroxide ion-conductive membrane, and an anode catalyst layer are laminated in this order, in which a tensile strength (a) and a breaking elongation (b) of a water-swollen body of a polymer contained in the cathode catalyst layer and/or the anode catalyst layer and a tensile strength (c) and a breaking elongation (d) of a water-swollen body of a hydroxide ion-conductive polymer constituting the hydroxide ion-conductive membrane satisfy the following relationships (Ri) and (Rii),

$$t ensile strength ( a ) > tensile strength ( c ) , \qquad ( Ri )$$

$$b reaking elongation ( b ) > breaking elongation ( d ) . \qquad ( Rii )$$

[2]

The membrane electrode assembly according to [1], in which an absolute value of a difference between a glass transition temperature (e) of the polymer that is contained in the cathode catalyst layer and/or the anode catalyst layer and satisfies the relationships (Ri) and (Rii), and a glass transition temperature (f) of the hydroxide ion-conductive polymer is 1° C. to 190° C.

[3]

The membrane electrode assembly according to [1] or [2], in which the polymer that is contained in the cathode catalyst layer and/or the anode catalyst layer and satisfies the relationships (Ri) and (Rii) is contained in a catalyst layer containing the polymer at a concentration of 5% to 25% by mass.

[4]

The membrane electrode assembly according to any one of [1] to [3], in which at least the polymer contained in the cathode catalyst layer satisfies the relationships (Ri) and (Rii).

[5]

The membrane electrode assembly according to any one of [1] to [4], in which the polymer contained in the anode catalyst layer satisfies the relationships (Ri) and (Rii).

[6]

The membrane electrode assembly according to any one of [1] to [5], in which a molecular weight of the polymer contained in the cathode catalyst layer and the anode catalyst layer is larger than a molecular weight of the hydroxide ion-conductive polymer.

[7]

A method for producing hydrogen using the membrane electrode assembly according to any one of [1] to [6].

[8]

A hydrogen production system comprising:
the membrane electrode assembly according to any one of [1] to [6].

The membrane electrode assembly according to an aspect of the present invention has low gas permeability and low ion resistance and capable of sufficiently maintaining a low resistance even in a case where on/off switching of energization or liquid supply is repeated. According to the method for producing hydrogen and the hydrogen production system according to an aspect of the present invention, since the membrane electrode assembly used has the above-described characteristics, hydrogen can be produced while sufficiently maintaining a low resistance even in a case where on/off switching of energization or liquid supply is repeated.

### BRIEF DESCRIPTION OF THE DRAWINGS

FIG. 1 is a longitudinal cross-sectional view schematically showing a basic laminated configuration of an embodiment of a membrane electrode assembly according to the present invention.

### DESCRIPTION OF THE PREFERRED EMBODIMENTS

### [Membrane Electrode Assembly]

The membrane electrode assembly according to the embodiment of the present invention can be widely used as a membrane electrode assembly in water electrolysis, a fuel cell, carbon dioxide reduction, protonation of toluene, and the like.

Among these, the membrane electrode assembly according to the embodiment of the present invention is suitable as a membrane electrode assembly used in water electrolysis. The membrane electrode assembly according to the embodiment of the present invention has excellent hydroxide ion conductivity (low ion resistance) and sufficiently low gas permeability.

The membrane electrode assembly according to the embodiment of the present invention has a structure in which a cathode catalyst layer, a hydroxide ion-conductive membrane, and an anode catalyst layer are laminated in this order. In addition, a tensile strength (a) and a breaking elongation (b) of a water-swollen body of a polymer contained in the cathode catalyst layer and/or the anode catalyst layer and a tensile strength (c) and a breaking elongation (d) of a water-swollen body of a hydroxide ion-conductive polymer constituting the hydroxide ion-conductive membrane satisfy the following relationships (Ri) and (Rii).

$$Tensile strength ( a ) > tensile strength ( c ) \qquad ( Ri )$$

$$Breaking elongation ( b ) > breaking elongation ( d ) \qquad ( Rii )$$

In the following description, the hydroxide ion-conductive polymer constituting the hydroxide ion-conductive membrane may be referred to as a “hydroxide ion-conductive membrane-forming polymer”. In addition, the term “catalyst layer” alone means both the cathode catalyst layer and the anode catalyst layer.

In the membrane electrode assembly according to the embodiment of the present invention, in a water-swollen state, the polymer contained in the catalyst layer has a property of being less likely to break and more likely to stretch than the hydroxide ion-conductive membrane-forming polymer. As a result, it is considered that the catalyst layer easily follows swelling and shrinking of the hydroxide ion-conductive membrane, and the durability can be improved while maintaining a low resistance.

The relationships (Ri) and (Rii) only need to be satisfied between the polymer contained in at least one of the cathode catalyst layer or the anode catalyst layer and the hydroxide ion-conductive membrane-forming polymer.

That is, in one aspect of the membrane electrode assembly according to the embodiment of the present invention, the polymer contained in the cathode catalyst layer and the hydroxide ion-conductive membrane-forming polymer satisfy the relationships (Ri) and (Rii), and the polymer contained in the anode catalyst layer and the hydroxide ion-conductive membrane-forming polymer do not satisfy the relationships (Ri) and (Rii).

In addition, in another aspect of the membrane electrode assembly according to the embodiment of the present invention, the polymer contained in the anode catalyst layer and the hydroxide ion-conductive membrane-forming polymer satisfy the relationships (Ri) and (Rii), and the polymer contained in the cathode catalyst layer and the hydroxide ion-conductive membrane-forming polymer do not satisfy the relationships (Ri) and (Rii).

In addition, in still another aspect of the membrane electrode assembly according to the embodiment of the present invention, the polymer contained in the cathode catalyst layer and the hydroxide ion-conductive membrane-forming polymer satisfy the relationships (Ri) and (Rii), and the polymer contained in the anode catalyst layer and the hydroxide ion-conductive membrane-forming polymer satisfy the relationships (Ri) and (Rii).

In the present invention, from the viewpoint of further reducing the gas permeability, it is preferable that at least the polymer contained in the cathode catalyst layer and the hydroxide ion-conductive membrane-forming polymer satisfy the relationships (Ri) and (Rii).

The tensile strength (a), the breaking elongation (b), the tensile strength (c), and the breaking elongation (d) can be measured by the methods described in Examples.

The tensile strength and the breaking elongation can be controlled by adjusting the constituent components, the molecular weight, the crosslinking density, and the like of the polymer.

The polymer contained in the cathode catalyst layer and the polymer contained in the anode catalyst layer may be the same polymer or may be different from each other.

Here, the term “polymers different from each other” means polymers that are different from each other in at least one of the tensile strength or the breaking elongation, and the difference or similarity in the constituent components of the polymers is not a problem. That is, even in a case where the constituent components (types of monomers used) of the polymer contained in the cathode catalyst layer and the constituent components (types of monomers used) of the polymer contained in the anode catalyst layer are the same, and the characteristics are different from each other due to the difference in the molecular weight, the constituent component ratio, the crosslinking density, and the like, the polymers are “polymers different from each other”.

The polymer contained in the cathode catalyst layer, the polymer contained in the anode catalyst layer, and the hydroxide ion-conductive membrane-forming polymer may be the same (the constituent components constituting the polymers are the same) or different from each other in terms of the polymer species, and from the viewpoint of further increasing the affinity between the catalyst layer and the hydroxide ion-conductive membrane, it is preferable that the polymer species are the same.

In the relationship (Ri), a difference ([tensile strength (a)]−[tensile strength (c)]) between the tensile strength (a) and the tensile strength (c) is preferably 5 MPa or more, more preferably 10 MPa or more, and still more preferably 20 MPa or more. The upper limit of the difference between the tensile strength (a) and the tensile strength (c) is not particularly limited, and is preferably 100 MPa or less. Therefore, the difference between the tensile strength (a) and the tensile strength (c) is preferably 5 to 100 MPa and more preferably 20 to 100 MPa. The difference between the tensile strength (a) and the tensile strength (c) can be set to 20 to 80 MPa, 20 to 60 MPa, 20 to 40 MPa, 20 to 28 MPa, or 20 to 26 MPa.

In the relationship (Rii), a difference ([breaking elongation (b)]−[breaking elongation (d)]) between the breaking elongation (b) and the breaking elongation (d) is preferably 5% or more, more preferably 10% or more, and still more preferably 20% or more. The upper limit of the difference between the breaking elongation (b) and the breaking elongation (d) is not particularly limited, and is preferably 400% or less. Therefore, the difference between the breaking elongation (b) and the breaking elongation (d) is preferably 5% to 400% and more preferably 20% to 400%. The difference between the breaking elongation (b) and the breaking elongation (d) can be set to 20% to 300%, 20% to 200%, 20% to 100%, or 25% to 100%.

In a case where the polymer contained in the cathode catalyst layer satisfies the relationships (Ri) and (Rii), a tensile strength (a1) of a water-swollen body of the polymer contained in the cathode catalyst layer is preferably 10 MPa or more, more preferably 20 MPa or more, still more preferably 30 MPa or more, and even more preferably 40 MPa or more. The tensile strength (a1) of the water-swollen body of the polymer contained in the cathode catalyst layer is usually 500 MPa or less and may be 450 MPa or less. Therefore, the tensile strength (a1) is preferably 10 to 500 MPa, more preferably 10 to 450 MPa, still more preferably 10 to 300 MPa, and most preferably 10 to 200 MPa. In addition, the tensile strength (a1) can be set to 20 to 200 MPa, 20 to 100 MPa, 20 to 80 MPa, or 20 to 70 MPa.

In a case where the polymer contained in the cathode catalyst layer satisfies the relationships (Ri) and (Rii), a breaking elongation (b1) of a water-swollen body of the polymer contained in the cathode catalyst layer is preferably 10% or more, more preferably 20% or more, still more preferably 30% or more, and even more preferably 50% or more. The breaking elongation (b1) of the water-swollen body of the polymer contained in the cathode catalyst layer is usually 500% or less and may be 400% or less. Therefore, the breaking elongation (b1) is preferably 10% to 500%, more preferably 20% to 400%, and still more preferably 50% to 400%. The breaking elongation (b1) can be set to 30% to 300%, 30% to 200%, or 50% to 100%.

In a case where the polymer contained in the anode catalyst layer satisfies the relationships (Ri) and (Rii), a tensile strength (a2) of a water-swollen body of the polymer contained in the anode catalyst layer is preferably 10 MPa or more, more preferably 20 MPa or more, still more preferably 30 MPa or more, and even more preferably 40 MPa or more. The tensile strength (a2) of the water-swollen body of the polymer contained in the anode catalyst layer is usually 500 MPa or less and may be 450 MPa or less. Therefore, the tensile strength (a2) is preferably 10 to 500 MPa, more preferably 10 to 450 MPa, still more preferably 10 to 300 MPa, and most preferably 10 to 200 MPa. In addition, the tensile strength (a2) can be set to 20 to 200 MPa, 20 to 100 MPa, or 20 to 80 MPa.

In a case where the polymer contained in the anode catalyst layer satisfies the relationships (Ri) and (Rii), a breaking elongation (b2) of a water-swollen body of the polymer contained in the anode catalyst layer is preferably 10% or more, more preferably 20% or more, still more preferably 30% or more, and even more preferably 50% or more. The breaking elongation (b2) of the water-swollen body of the polymer contained in the anode catalyst layer is usually 500% or less and may be 400% or less. Therefore, the breaking elongation (b2) is preferably 10% to 500%, more preferably 20% to 400%, and still more preferably 50% to 400%. The breaking elongation (b2) can be set to 30% to 300%, 30% to 200%, or 50% to 100%.

The tensile strength (c) of the water-swollen body of the hydroxide ion-conductive membrane-forming polymer is preferably 5 MPa or more, more preferably 10 MPa or more, and still more preferably 12 MPa or more. The tensile strength (c) of the hydroxide ion-conductive membrane-forming polymer is usually 400 MPa or less and may be 300 MPa or less. Therefore, the tensile strength (c) is preferably 5 to 400 MPa, more preferably 10 to 300 MPa, still more preferably 10 to 100 MPa, and most preferably 10 to 60 MPa. In addition, the tensile strength (c) can be set to 10 to 40 MPa or 10 to 30 MPa.

The breaking elongation (d) of the water-swollen body of the hydroxide ion-conductive membrane-forming polymer is preferably 5% or more, more preferably 10% or more, and still more preferably 20% or more. The breaking elongation (d) of the hydroxide ion-conductive membrane-forming polymer is usually 400% or less and may be 300% or less. Therefore, the breaking elongation (d) is preferably 5% to 400%, more preferably 10% to 300%, and still more preferably 20% to 300%. The breaking elongation (d) can be set to 10% to 200%, 10% to 100%, or 10% to 80%.

An absolute value of a difference between a glass transition temperature (e) of the polymer that is contained in the cathode catalyst layer and/or the anode catalyst layer and satisfies the relationships (Ri) and (Rii) and a glass transition temperature (f) of the hydroxide ion-conductive membrane-forming polymer is preferably 1° C. to 200° C., more preferably 1° C. to 190° C., still more preferably 1° C. to 150° C., even more preferably 1° C. to 140° C., even still more preferably 1° C. to 50° C., and even still more preferably 1° C. to 40° C. The absolute value of the difference can be set to 10° C. to 80° C., 15° C. to 80° C., or 20° C. to 60° C.

That is, in a case where the catalyst layer satisfying the relationships (Ri) and (Rii) is the cathode catalyst layer, it is preferable that a glass transition temperature (e1) of the polymer contained in the cathode catalyst layer and the glass transition temperature (f) of the hydroxide ion-conductive membrane-forming polymer satisfy the above-described relationship. In addition, in a case where the catalyst layer satisfying the relationships (Ri) and (Rii) is the anode catalyst layer, it is preferable that a glass transition temperature (e2) of the polymer contained in the anode catalyst layer and the glass transition temperature (f) of the hydroxide ion-conductive membrane-forming polymer satisfy the above-described relationship. In addition, in a case where the catalyst layer satisfying the relationships (Ri) and (Rii) is both the cathode catalyst layer and the anode catalyst layer, it is preferable that both the glass transition temperature (e1) and the glass transition temperature (e2) satisfy the above-described relationship with the glass transition temperature (f) of the hydroxide ion-conductive membrane-forming polymer.

It is noted that in a case where each of the polymers has two or more glass transition temperatures, the smallest glass transition temperature of each polymer is used for comparison.

It is more preferable that the glass transition temperature (e) of the polymer that is contained in the cathode catalyst layer and/or the anode catalyst layer and satisfies the relationships (Ri) and (Rii) and the glass transition temperature (f) of the hydroxide ion-conductive membrane-forming polymer satisfy a relationship of glass transition temperature (e)>glass transition temperature (f).

The glass transition temperature (e) is preferably −80° C. or higher, more preferably −60° C. or higher, and still more preferably −50° C. or higher. The glass transition temperature (e) is usually 250° C. or lower and may be 200° C. or lower. Therefore, the glass transition temperature (e) is preferably −80° C. to 250° C., more preferably −60° C. to 200° C., and still more preferably −50° C. to 200° C.

The glass transition temperature (f) is preferably −100° C. or higher, more preferably −90° C. or higher, and still more preferably −80° C. or higher. The glass transition temperature (f) is usually 180° C. or lower and may be 150° C. or lower. Therefore, the glass transition temperature (f) is preferably −100° C. to 180° C., more preferably −90° C. to 150° C., and still more preferably −80° C. to 150° C.

In the relationship between (e) and (f), a difference ([glass transition temperature (e)]−[glass transition temperature (f)]) between the glass transition temperature (e) and the glass transition temperature (f) is preferably 5° C. or more and preferably 10° C. or more. Therefore, the difference between the glass transition temperature (e) and the glass transition temperature (f) is preferably 5° C. to 150° C.

The glass transition temperature of each polymer can be measured as follows.

### —Glass Transition Temperature—

In a case of using a commercially available polymer, a glass transition temperature of the polymer is adopted as a value described in a catalog of a manufacturer.

In a case where information on the glass transition temperature of the manufacturer is not available or in a case of using synthesized polymer particles, a value of the glass transition temperature in a table of Chapter 36 of POLYMER HANDBOOK 4th is adopted. In a case where the glass transition temperature is not described in the above-described document, a value of the glass transition temperature measured under the following measurement conditions is adopted.

The glass transition temperature (Tg) was calculated by measuring under the following measurement conditions by using a dry sample of the monomer and a differential scanning calorimeter: X-DSC7000 (trade name, manufactured by SII NanoTechnology Inc.). The measurement is carried out twice for the same sample, and the result of the second measurement is employed.

### (Measurement Conditions)

Atmosphere in measurement chamber: nitrogen gas (50 mL/min)
Temperature increase rate: 5° C./min
Measurement start temperature: −80° C.
Measurement end temperature: 250° C.
Specimen pan: aluminum pan
Mass of measurement sample: 5 mg

Calculation of Tg: Tg is calculated by rounding off the decimal point in the intermediate temperature between the descent start point and the descent end point of the differential scanning calorimetry (DSC) chart.

A molecular weight of the polymer that is contained in the cathode catalyst layer and/or the anode catalyst layer and satisfies the relationships (Ri) and (Rii) is preferably larger than a molecular weight of the hydroxide ion-conductive membrane-forming polymer. In the present invention, the molecular weight of the polymer is a weight-average molecular weight.

A difference between the molecular weight of the polymer that is contained in the cathode catalyst layer and/or the anode catalyst layer and satisfies the relationships (Ri) and (Rii) and the molecular weight of the hydroxide ion-conductive membrane-forming polymer is preferably 1,000 or more. The upper limit of the difference between the molecular weight of the polymer that is contained in the cathode catalyst layer and/or the anode catalyst layer and satisfies the relationships (Ri) and (Rii) and the molecular weight of the hydroxide ion-conductive membrane-forming polymer is not particularly limited and is preferably 10,000. Therefore, the difference between the molecular weight of the polymer that is contained in the cathode catalyst layer and/or the anode catalyst layer and satisfies the relationships (Ri) and (Rii) and the molecular weight of the hydroxide ion-conductive membrane-forming polymer is preferably 1,000 to 10,000 and preferably 1,000 to 7,000.

The molecular weight of the polymer that is contained in the cathode catalyst layer and/or the anode catalyst layer and satisfies the relationships (Ri) and (Rii) is preferably 1,500 or more, more preferably 2,000 or more, still more preferably 5,000 or more, and even more preferably 10,000 or more. The molecular weight of the polymer is usually 5,000,000 or less and may be 1,000,000 or less. Therefore, the molecular weight of the polymer is preferably 1,500 to 5,000,000, more preferably 2,000 to 5,000,000, still more preferably 2,000 to 1,000,000, and even more preferably 5,000 to 1,000,000. The molecular weight of the polymer can be set to 2,000 to 500,000 or 2,000 to 100,000.

The molecular weight of the hydroxide ion-conductive membrane-forming polymer is preferably 500 or more and more preferably 1,000 or more. The molecular weight of the hydroxide ion-conductive membrane-forming polymer is usually 5,000,000 or less and may be 1,000,000 or less. Therefore, the molecular weight of the hydroxide ion-conductive membrane-forming polymer is preferably 500 to 5,000,000, more preferably 1,000 to 1,000,000, still more preferably 1,000 to 100,000, even more preferably 1,000 to 10,000, and even still more preferably 1,000 to 6,000.

### —Measurement of Molecular Weight of Polymer—

In the present invention, the molecular weight of the polymer is measured by gel permeation chromatography (GPC). The molecular weight refers to a weight-average molecular weight in terms of polyethylene oxide. Regarding a measurement method, basically, a value measured by a method of the following measurement condition 1 is used. In this case, an appropriate eluent may be selected and used depending on the type of the polymer.

### (Measurement Condition 1)

Measuring instrument: HLC-8220GPC (trade name, manufactured by Tosoh Corporation)
Column: TOSOH TSKgel 5000PWXL (trade name, manufactured by Tosoh Corporation), TOSOH TSKgel G4000PWXL (trade name, manufactured by Tosoh Corporation), and TOSOH TSKgel G2500PWXL (trade name, manufactured by Tosoh Corporation) are connected.
Carrier: 200 mM aqueous sodium nitrate solution
Measurement temperature: 40° C.
Carrier flow rate: 1.0 ml/min
Sample concentration: 0.2% by mass
Detector: refractive index (RI) detector

In a case where the molecular weight cannot be measured under the measurement condition 1, such as in a case of having a crosslinked structure, the molecular weight is measured by static light scattering under the following measurement condition 2.

### (Measurement Condition 2)

Measuring instrument: DLS-8000 (trade name, manufactured by OTSUKA ELECTRONICS CO., LTD)
Measurement concentration: 0.25, 0.50, 0.75, 1.00 mg/mL
Solution for dilution: 0.1M NaCl aqueous solution
Laser wavelength: 633 nm
Pinhole: PH1=Open, PH2=Slit
Measurement angles: 60, 70, 80, 90, 100, 110, 120, 130 degrees

Analysis method: Square root Zimm plot is used to measure molecular weight. dn/dc required for analysis is actually measured with an Abbe refractometer.

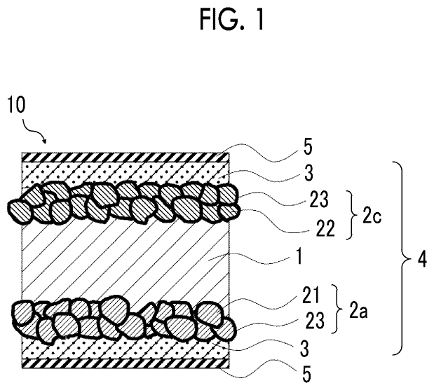

FIG. 1 shows a preferred form of the membrane electrode assembly according to the embodiment of the present invention. In the membrane electrode assembly 4 of FIG. 1, a cathode catalyst layer 2c is formed on one surface of the hydroxide ion-conductive membrane 1, an anode catalyst layer 2a is formed on the other surface, and a gas diffusion layer 3 is formed on a surface of each of the catalyst layers opposite to the hydroxide ion-conductive membrane 1. The membrane electrode assembly 4 has a laminated structure in which the gas diffusion layer 3, the cathode catalyst layer 2c, the hydroxide ion-conductive membrane 1, the anode catalyst layer 2a, the gas diffusion layer 3 are laminated in this order. The anode catalyst layer 2a contains a particulate anode catalyst 21 and a polymer 23 that also functions as a binder, and the anode catalyst 21 is bound by the polymer 23. The cathode catalyst layer 2c contains a particulate cathode catalyst 22 and a polymer 23 that also functions as a binder, and the cathode catalyst 22 is bound by the polymer 23. In FIG. 1, a bipolar plate 5 is further formed on a surface of the two gas diffusion layers 3 of the membrane electrode assembly 4 opposite to the catalyst layer, and the form of a water electrolysis cell 10 is adopted.

Each member constituting the membrane electrode assembly will be described.

### <Hydroxide Ion-Conductive Membrane>

In the present invention, the term “having hydroxide ion conductivity” means that an ion conductivity obtained by the following method is 0.1 mS/cm or more.

### —Ion Conductivity—

A striped test piece of 10 mm×50 mm is sandwiched in BT-115 of Electro Chem Co., Ltd. or a jig (attachment with electrode) described in Electrochemistry, 85, 40, and an alternating current impedance measurement is performed by a four-terminal method. The alternating current impedance measurement is performed in a 1 M KOH aqueous solution heated to 45° C., with a voltage of 10 m V and a frequency in a range of 1 MHz to 0.1 Hz. A value of an intercept on the real axis in a case of obtaining a Nyquist plot (an extrapolated value may be used) is defined as a resistance value R of the test piece, and the ion conductivity σ is calculated from the following expression.

$$Ion conductivity σ ( S / cm ) = D ( cm ) / ( W ( cm ) \times T ( cm ) \times resistance value R ( Ω ) )$$

D: length (cm) of test piece
W: width (cm) of test piece
T: thickness (cm) of test piece

In the present invention, the hydroxide ion conductivity of the hydroxide ion-conductive membrane is preferably 0.1 mS/cm to 10 S/cm, more preferably 10 mS/cm to 1 S/cm, and still more preferably 10 mS/cm to 500 mS/cm.

The hydroxide ion-conductive membrane can have a form of a membrane (single membrane) formed of the hydroxide ion-conductive polymer. In addition, the hydroxide ion-conductive membrane can also have a form including a porous substrate and the hydroxide ion-conductive polymer. For example, the hydroxide ion-conductive membrane can have a form of a laminate of the membrane of the hydroxide ion-conductive polymer and the porous substrate. In addition, the hydroxide ion-conductive membrane can also have a form of a composite body including the porous substrate and the hydroxide ion-conductive polymer disposed at least in a pore of the porous substrate. In the form of the composite body, the hydroxide ion-conductive polymer may be disposed at least in the pore of the porous substrate, and the hydroxide ion-conductive polymer may be disposed in a portion of the porous substrate other than the pore in addition to the pore of the porous substrate. For example, in the form of the composite body, the hydroxide ion-conductive polymer may cover a surface of the porous substrate.

In the present invention, the hydroxide ion-conductive membrane preferably has a form of a membrane (single membrane not including a porous substrate) formed of the hydroxide ion-conductive polymer.

### —Hydroxide Ion-Conductive Polymer—

As the hydroxide ion-conductive polymer, a polymer having hydroxide ion conductivity that can be used in a membrane electrode assembly used in water electrolysis, a fuel cell, and the like can be widely used. Examples thereof include an ionomer, a high water content polymer having a polar group, and the like.

The hydroxide ion-conductive polymer may be an ionic polymer or a nonionic polymer.

As the ionomer, an anionic ionomer is preferable.

As the ionomer, a sulfonated plastic-based electrolyte such as perfluoroalkane sulfonic acid, sulfonated polyether ketone, sulfonated polyether sulfone, sulfonated polyether ether sulfone, sulfonated polysulfone, sulfonated polysulfide, or sulfonated polyphenylene, a sulfoalkylated plastic-based electrolyte such as sulfoalkylated polyether ether ketone, sulfoalkylated polyether sulfone, sulfoalkylated polyether ether sulfone, sulfoalkylated polysulfone, sulfoalkylated polysulfide, or sulfoalkylated polyphenylene, or the like can be used.

Examples of the high water content polymer having a polar group include a hydrocarbon polymer (preferably a polyolefin, more preferably polyethylene or polypropylene), polyethylene glycol, polyacrylamide, and the like.

It is preferable that the hydroxide ion-conductive polymer does not have a sulfo group.

In the present invention, it is preferable that the hydroxide ion-conductive polymer contains a constituent component (I) derived from a polyfunctional polymerizable monomer (hereinafter, also simply referred to as a “polyfunctional polymerizable monomer IA”) having a total of two or more atoms of at least one of an oxygen atom, a sulfur atom, or a nitrogen atom (hereinafter, also collectively referred to as “heteroatoms”) in a structural moiety other than a polymerizable group.

In the polymer, a proportion of the constituent component (I) in all the constituent components is preferably 20% by mass or more and more preferably 30% by mass or more.

That is, it is preferable that the hydroxide ion-conductive polymer having the constituent component (I) is a polymer obtained by polymerizing a polymerizable monomer-containing liquid containing 20% by mass or more of the polyfunctional polymerizable monomer IA in all the monomers. A three-dimensional mesh structure is formed by the polymerization to generate the hydroxide ion-conductive polymer.

In the hydroxide ion-conductive polymer having the constituent component (I), since a structural moiety having the above-described heteroatom can effectively increase the polarity of the polymer, the polymer can stably retain a large amount of moisture, thereby exhibiting excellent hydroxide ion conductivity.

The polyfunctional polymerizable monomer IA from which the constituent component (I) is derived will be described.

In the present invention, the term “polyfunctional polymerizable monomer” means a monomer having two or more polymerizable groups in one molecule. That is, the term “polyfunctional” means having two or more polymerizable groups in one molecule.

In a case where the polymerizable group is a chain-polymerizable group, the polyfunctional polymerizable monomer IA is preferably a 2- to 6-valent polyfunctional polymerizable monomer (that is, a monomer having two to six chain-polymerizable groups in one molecule), and preferably a 2- to 4-valent polyfunctional polymerizable monomer.

In a case where the polymerizable group is a stepwise-polymerizable group, the polyfunctional polymerizable monomer IA is preferably a 2- to 6-valent polyfunctional polymerizable monomer (that is, a monomer having two to six stepwise polymerizable groups in one molecule), preferably a 2- to 5-valent polyfunctional polymerizable monomer, preferably a 2- to 4-valent polyfunctional polymerizable monomer, and preferably a 3- to 4-valent polyfunctional polymerizable monomer.

By using the polyfunctional polymerizable monomer, a crosslinking structure is likely to be formed in a large amount in the obtained polymer as compared with a case of using a monofunctional polymerizable monomer, and a dense membrane can be formed.

The polymerizable group included in the polyfunctional polymerizable monomer IA is not particularly limited as long as it can cause a polymerization reaction, and examples thereof include a chain-polymerizable group (for example, a group having a carbon-carbon double bond such as a vinyl group (CH₂═CH—), a vinyl ether group (CH₂═CH—O—), a vinylthioether group (CH₂═CH—S—), an acryloyl group (CH₂═CH—C(═O)—), a methacryloyl group (CH₂═C(CH₃)—C(═O)—), or a derivative thereof; an epoxy group (oxiranyl group), a cyclic ether group such as an oxetanyl group), and as a group capable of stepwise polymerization, a group causing polycondensation or polyaddition (a hydroxy group, an unsubstituted amino group, a carboxy group, a sulfo group, an isocyanate group, an acid anhydride group, and the like).

It is preferable that the polyfunctional polymerizable monomer IA has two or more chain-polymerizable groups. In addition, the polyfunctional polymerizable monomer IA may have both the chain-polymerizable group and the stepwise-polymerizable group. In addition, it is also preferable that the polyfunctional polymerizable monomer IA has two or more chain-polymerizable groups and does not have a stepwise-polymerizable group.

It is noted that in the present invention, the term “stepwise-polymerizable group” means a group that reacts with another group in a polymerization reaction condition of the polyfunctional polymerizable monomer IA for obtaining the hydroxide ion-conductive polymer to cause stepwise polymerization. That is, in the polymerization reaction condition, for example, in a case where the above-described “other group” does not exist and stepwise polymerization cannot occur (that is, in a case where the group remains as an unreacted group in the obtained hydroxide ion-conductive polymer), even in a case where the polyfunctional polymerizable monomer IA has a group that is listed as a group capable of stepwise polymerization such as the hydroxy group, the unsubstituted amino group, the carboxy group, the sulfo group, the isocyanate group, and the acid anhydride group, these groups are not “stepwise-polymerizable groups”. Even in a case where the group that is listed as a group capable of stepwise polymerization cannot cause stepwise polymerization under the above-described polymerization reaction condition, an oxygen atom, a nitrogen atom, and the like constituting these groups constitute a heteroatom present in a structural moiety of the polyfunctional polymerizable monomer IA other than the polymerizable group.

The above-described “polymerizable group” is preferably a group selected from a vinyl group, a vinyl ether group, a vinylthioether group, an acryloyl group, a methacryloyl group, an epoxy group, or an oxetanyl group, and more preferably a group selected from a vinyl group, an acryloyl group, a methacryloyl group, or an epoxy group. It is noted that in a case where the polyfunctional polymerizable monomer IA has a styryl group, the above-described “polymerizable group” is a vinyl group. That is, a benzene ring constituting the styryl group constitutes a “structural moiety other than polymerizable group” defined in the present invention. Similarly, in a group having a vinyl group and other than a vinyl ether group, a vinylthioether group, an acryloyl group, and a methacryloyl group, the vinyl group corresponds to the polymerizable group, and a portion other than the vinyl group is regards as constituting the “structural moiety other than polymerizable group” defined in the present invention.

On the other hand, in the present invention, an ether group (—O—) included in the vinyl ether group which is a chain-polymerizable group, a thioether group (—S—) included in the vinylthioether group, a carbonyl group (—C(═O)—) included in the acryloyl group and the methacryloyl group, and each heteroatom included in the hydroxy group, the amino group, the carboxy group, the isocyanate group, the sulfo group, and the acid anhydride, which are stepwise-polymerizable groups, are all regarded as a part of the structure of the “polymerizable group” contained in the polyfunctional polymerizable monomer IA. Therefore, the above-described heteroatom constituting these polymerizable groups is not an atom constituting a “structural moiety other than polymerizable group” defined in the present invention.

As described above, the polyfunctional polymerizable monomer IA has a total of two or more atoms of at least one of an oxygen atom, a sulfur atom, or a nitrogen atom in a structural moiety other than a polymerizable group (that is, the total number of oxygen atoms, sulfur atoms, and nitrogen atoms included in the structural moiety other than the polymerizable group is two or more). A combinations of these atoms are not particularly limited, and a structure may be such that a structural moiety other than a polymerizable group has two or more oxygen atoms and has no sulfur atoms or nitrogen atoms, such that a structural moiety other than the polymerizable group has two or more sulfur atoms and has no oxygen atoms or nitrogen atoms, or such that a structural moiety other than the polymerizable group has two or more nitrogen atoms and has no oxygen atoms or sulfur atoms. In addition, two or more heteroatoms of two or more different types may be present in combination (for example, a structure may have one sulfur atom and one oxygen atom).

The total number of oxygen atoms, sulfur atoms, and nitrogen atoms included in the structural moiety other than the polymerizable group of the polyfunctional polymerizable monomer IA depends on the size of the structural moiety other than the polymerizable group, but is preferably 2 to 160, more preferably 2 to 150, still more preferably 2 to 140, even more preferably 4 to 140, even still more preferably 8 to 100, and particularly preferably 10 to 50.

The structural moiety other than the polymerizable group of the polyfunctional polymerizable monomer IA usually has an atom other than an oxygen atom, a sulfur atom, and a nitrogen atom. The atom other than the oxygen atom, the sulfur atom, and the nitrogen atom included in the structural moiety is not particularly limited. The atom other than the oxygen atom, the sulfur atom, and the nitrogen atom included in the structural moiety is typically a carbon atom and a hydrogen atom. In addition, in a case where the structural moiety has a cationic or anionic structure, an atom other than the oxygen atom, the sulfur atom, and the nitrogen atom can be used as a counterion. For example, in a case where the structural moiety other than the polymerizable group of the polyfunctional polymerizable monomer IA has a cationic structure having a quaternary ammonium group, a halogen ion, a hydroxide ion, a carbonate ion, or the like can be used as a counterion.

It is preferable that the polyfunctional polymerizable monomer IA does not have a fluorine atom in the structure thereof. By not having a fluorine atom, there is a tendency to be able to achieve both high ion conductivity and high gas barrier properties.

The structural moiety other than the polymerizable group of the polyfunctional polymerizable monomer IA may be linear, may have a branched structure, or may have a cyclic structure.

In the structural moiety other than the polymerizable group of the polyfunctional polymerizable monomer IA, the number of atoms constituting a shortest connecting structure that links two adjacent heteroatoms is preferably 6 or less, more preferably 5 or less, still more preferably 4 or less, and even more preferably 3 or less. For example, in the structures (i) and (ii) described later, the atom constituting the shortest connecting structure between two adjacent oxygen atoms is a carbon atom, and the number of atoms (number of carbon atoms) constituting the shortest connecting structure is 2. In addition, in the structure (iii), the atom constituting the shortest connecting structure between two adjacent oxygen atoms is a carbon atom, and the number of atoms (number of carbon atoms) constituting the shortest connecting structure is 1. In addition, in the structure (iv), in a case where L is a phenylene having two linking sites in a para relationship with each other, the atom constituting the shortest connecting structure between the adjacent sulfur atom and oxygen atom via the phenylene is a carbon atom, and the number of atoms (carbon atom number) constituting the shortest connecting structure is 4. In addition, in the structure (iv), since there is no atom between two adjacent heteroatoms in the (—S(═O)₂—) structure, the number of atoms constituting the above-described “shortest connecting structure” in the (—S(═O)₂—) structure is 0. In addition, in the structures (v) to (vii), the atom constituting the shortest connecting structure between two nitrogen atoms is a carbon atom, and the number of atoms (number of carbon atoms) constituting the shortest connecting structure is 2. In addition, in the structures (viii), the atom constituting the shortest connecting structure between two nitrogen atoms is a carbon atom, and the number of atoms (number of carbon atoms) constituting the shortest connecting structure is 6.

The structural moiety other than the polymerizable group of the polyfunctional polymerizable monomer IA has two or more groups selected from an oxygen atom, a sulfur atom, and a nitrogen atom to form a structure having high polarity. Specific examples of the structure having a total of two or more atoms of at least one of an oxygen atom, a sulfur atom, or a nitrogen atom in the structural moiety include a polyalkyleneoxy structure, a carbonate structure (—O—C(═O)—O—), a structure having one or more sulfonyl groups (—S(═O)₂—), a structure in which a sulfonyl group (—S(═O)₂—) and an ether group (—O—) are combined (for example, —O—(CH₂)₂—S(═O)₂—(CH₂)₂—O—), a structure having two or more imino groups (for example, a polyethyleneimine structure), a structure having two or more quaternary ammonium groups, and the like.

The polyfunctional polymerizable monomer IA has two or more groups selected from an oxygen atom, a sulfur atom, and a nitrogen atom in a structural moiety other than the polymerizable group to form a structure having high polarity, and the hydroxide ion-conductive polymer obtained by polymerizing the structure or the hydroxide ion-conductive membrane including the polymer can retain a larger amount of moisture and can have higher hydroxide ion conductivity.

In the polyfunctional polymerizable monomer IA, a chemical formula weight of the structural moiety other than the polymerizable group is preferably 30 to 4,000, more preferably 50 to 3,000, still more preferably 100 to 2,000, and particularly preferably 100 to 1,000. In the polyfunctional polymerizable monomer IA, a value obtained by dividing the “chemical formula weight of the structural moiety other than the polymerizable group” by the “total number of oxygen atoms, sulfur atoms, and nitrogen atoms included in the structural moiety other than the polymerizable group” (the “chemical formula weight of the structural moiety other than the polymerizable group”/the “total number of oxygen atoms, sulfur atoms, and nitrogen atoms included in the structural moiety other than the polymerizable group”) is preferably 2 to 100, more preferably 2 to 80, still more preferably 4 to 60, and particularly preferably 5 to 50.

A molecular weight of the polyfunctional polymerizable monomer IA is preferably 150 to 5,000, more preferably 180 to 4,500, and still more preferably 200 to 3,000.

The polyfunctional polymerizable monomer IA can have, for example, at least any one of the following structural moietys (i) to (viii) in the structural moiety other than the polymerizable group.

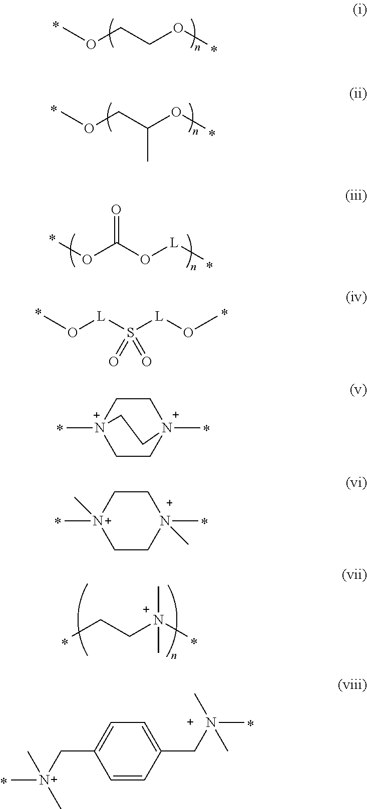

In the structural moieties (i) to (iii) and (vii), n is an integer of 1 or more, and is preferably 1 to 50, more preferably 2 to 35, still more preferably 3 to 30, even more preferably 4 to 25, even still more preferably 5 to 20, even still more preferably 5 to 15, and particularly preferably 5 to 10.

L represents a single bond, an alkylene group, or an arylene group. In a case where L represents an alkylene group, the number of carbon atoms in the alkylene group is preferably 1 to 10, more preferably 1 to 6, still more preferably 1 to 3, and even more preferably 1 or 2. In a case where L represents an arylene group, the number of carbon atoms in the arylene group is preferably 6 to 18, more preferably 6 to 14, and still more preferably 6 to 10. The arylene group is preferably a phenylene group.

* represents a linking site to another structure.

The structural moiety represented by Formula (iv) is preferably a structural moiety represented by Formula (ix), and is also preferably a structural moiety represented by Formula (x).

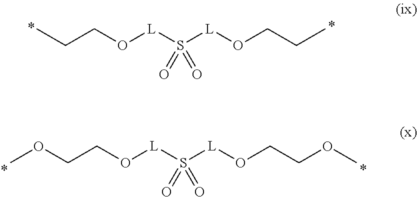

The constituent component (I) (constitutional unit derived from the polyfunctional polymerizable monomer IA) included in the hydroxide ion-conductive polymer is preferably a nonionic constituent component from the viewpoint of durability against high-temperature continuous operation under alkaline conditions. For example, the constituent component (I) preferably has at least any one of the above-described structural moieties (i) to (iv), and more preferably has the structural moiety (i) or (ii).

The hydroxide ion-conductive polymer can have one or two or more types of the constituent component (I). Here, the structural moiety (vii) has one nitrogen atom in the structure in parentheses, but in a case where the constituent component (I) has only the structural moiety (vii), n in the structural moiety (vii) is an integer of 2 or more, and in a case where the constituent component (I) has any one of (i) to (vi) and (viii) in addition to the structural moiety (vii), n in the structural moiety (vii) is an integer of 1 or more.

Preferred specific examples of the polyfunctional polymerizable monomer IA are shown below. n is an integer of 1 or more. It is noted that in the preferred specific examples of the polyfunctional polymerizable monomer IA, the hydroxide ion may be a halogen ion (for example, a chloride ion or the like) or a carbonate ion.

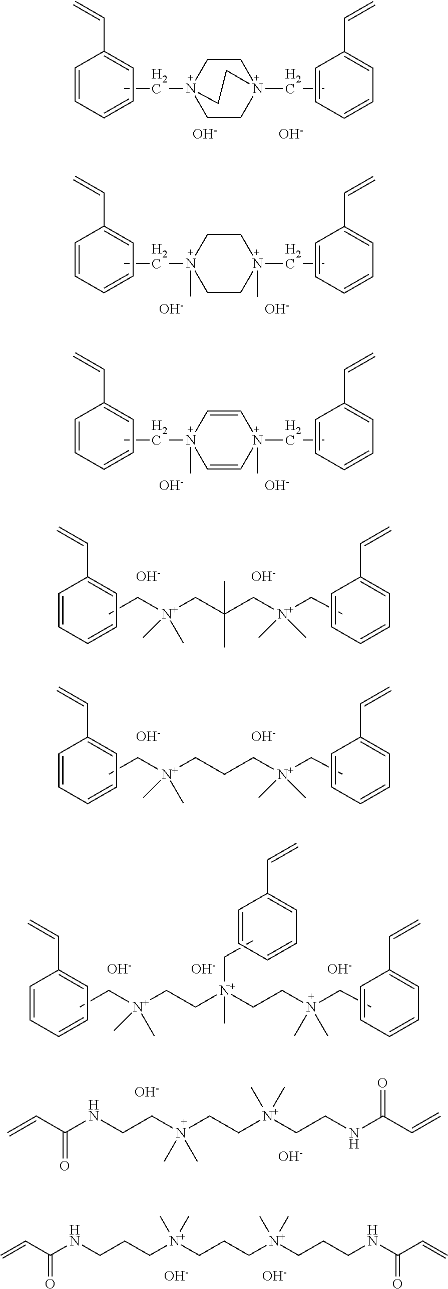

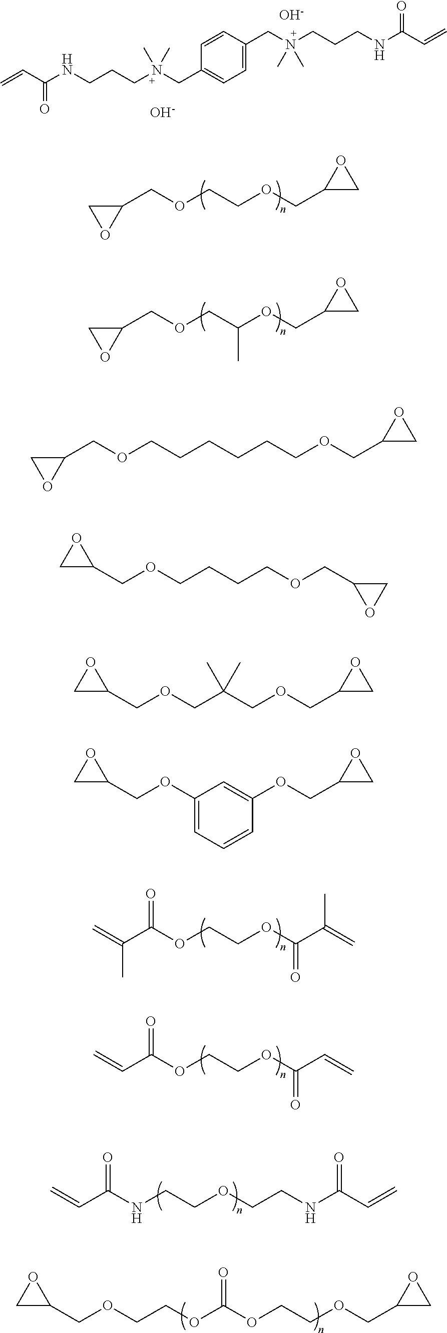

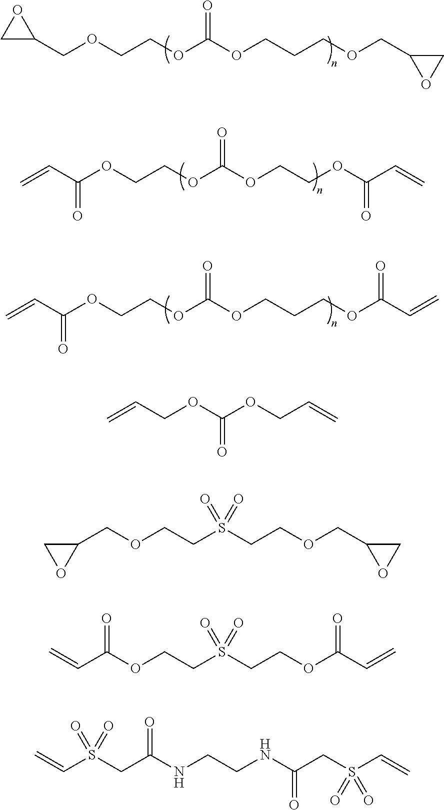

The hydroxide ion-conductive polymer may be a polymer consisting of the constituent component (I), or may contain a constituent component (II) derived from a monomer other than the polyfunctional polymerizable monomer IA in addition to the constituent component (I).

The constituent component (II) can be appropriately adopted without impairing the effects of the present invention. Examples of the constituent component (II) include a constituent component derived from a monofunctional or polyfunctional polymerizable monomer having one heteroatom in a structural moiety other than the polymerizable group, a constituent component derived from a monofunctional polymerizable monomer having a total of two or more of at least one heteroatom in a structural moiety other than the polymerizable group, and a constituent component derived from a monofunctional or polyfunctional polymerizable monomer having no heteroatoms in a structural moiety other than the polymerizable group, but the constituent component (II) is not limited thereto.

A polymerizable group that can be adopted by the polymerizable monomer from which the constituent component (II) is derived is the same as the polymerizable group included in the polyfunctional polymerizable monomer IA, and a preferred form of the polymerizable group is also the same. The polymerizable group that can be adopted by the polymerizable monomer from which the constituent component (II) is derived is a polymerizable group that can be subjected to a polymerization reaction with the polymerizable group included in the polyfunctional polymerizable monomer IA.

A molecular weight of the monomer from which the constituent component (II) is derived is preferably 50 to 20,000 and more preferably 100 to 10,000.

The constituent component (II) is preferably a structure having an aryl group, and the aryl group may further have a substituent. Among these, the constituent component (II) is preferably a structure having a benzene ring, and is more preferably a structure having one benzene ring.

The substituent is preferably a group having an ammonium group, a group having a primary to tertiary amine group, or the like.

A proportion of the constituent component (I) in all the constituent components of the hydroxide ion-conductive polymer is preferably 20% by mass or more, more preferably 30% by mass or more, and still more preferably 40% by mass or more, and may be 50% by mass or more, and all the constituent components of the hydroxide ion-conductive polymer may be the constituent component (I). By increasing the proportion of the constituent component (I), the gas permeability can be further reduced.

The hydroxide ion-conductive polymer can retain a larger amount of moisture due to the structure having high polarity of the constituent component (I). The water retention capacity of the hydroxide ion-conductive polymer is preferably 5% by mass or more, more preferably 5% to 30% by mass, still more preferably 5% to 27% by mass, even more preferably 10% to 27% by mass, and particularly preferably 18% to 25% by mass. The water retention capacity of the hydroxide ion-conductive polymer can be measured by the “method for measuring water retention capacity” described below.

### —Measurement of Water Retention Capacity—

A film having a thickness of 0.05 mm is produced for the hydroxide ion-conductive polymer. A test piece having a size of 1 cm in length×4 cm in width is cut out from the film of the hydroxide ion-conductive polymer, and this is used as a test piece.

For the test piece, a mass of the test piece after drying for 12 hours under vacuum at 60° C. is defined as WA, a mass of the test piece after 8 hours in a state where the entire dried test piece is completely immersed in a 0.2 M potassium hydroxide (KOH) aqueous solution is defined as WB, and the water retention capacity is calculated by the following numerical expression.

$$Water retention capacity ( \% ) = ( W B - WA ) / WB \times 100$$

The hydroxide ion-conductive polymer can be obtained by preparing a polymerizable monomer-containing liquid and subjecting the polymerizable monomer to a polymerization reaction.

In a case of preparing a polymer having the constituent component (I), the polymerizable monomers (the polyfunctional polymerizable monomer IA and the polymerizable monomer to be blended as necessary other than the polyfunctional polymerizable monomer IA) contained in the polymerizable monomer-containing liquid are as described above.

In a case of preparing a polymer having the constituent component (I), a proportion of the polyfunctional polymerizable monomer IA in all the polymerizable monomers in the polymerizable monomer-containing liquid is the same as the “proportion of the constituent component (I) in all the constituent components of the hydroxide ion-conductive polymer” described above. That is, the proportion of the polyfunctional polymerizable monomer IA in all the polymerizable monomers is preferably 20% by mass or more, more preferably 30% by mass or more, still more preferably 40% by mass or more, and may be 50% by mass or more, and all the polymerizable monomers may be the polyfunctional polymerizable monomer IA.

The polymerizable monomer-containing liquid may contain a solvent or may not contain a solvent.

Examples of the solvent include water, isopropyl alcohol, methanol, ethanol, acetonitrile, tetrahydrofuran (THF), and the like. These may be used by being mixed.

In a case of using a solvent, a solids content of the polymerizable monomer-containing liquid is preferably 30% by mass or more, more preferably 50% by mass or more, and still more preferably 75% by mass or more.

It is also preferable that the polymerizable monomer-containing liquid does not contain a solvent.

The polymerizable monomer-containing liquid may contain a polymerization initiator in addition to the polymerizable monomer. In a case where the polymerizable group of the monomer is a chain-polymerizable group, the polymerizable monomer-containing liquid usually contains a polymerization initiator. The polymerization initiator can be appropriately selected depending on the polymerizable group of the polymerizable monomer. As the polymerization initiator, a polymerization initiator selected from a photopolymerization initiator, a thermal polymerization initiator, a photocationic polymerization initiator, or a thermal cationic polymerization initiator is preferable, and these may be used in combination.

As the polymerization initiator, a polymerization initiator that is usually used for polymerization of the polymerizable monomer having a chain-polymerizable group can be used.

A content of the polymerization initiator in the polymerizable monomer-containing liquid is preferably 0.1 to 15 parts by mass, more preferably 0.5 to 10 parts by mass, and still more preferably 1 to 8 parts by mass with respect to 100 parts by mass of the total polymerizable monomers.

A method of subjecting the polymerizable monomer to a polymerization reaction is not particularly limited, and can be appropriately selected depending on the polymerizable group included in the polymerizable monomer and the type of the polymerization initiator. By this polymerization reaction, a hydroxide ion-conductive polymer having a three-dimensional mesh structure is formed.

In the polymerization reaction, it is preferable to polymerize the polymerizable monomer by any of light or heat. Conditions of the light irradiation and the heating can be appropriately set.

### —Porous Substrate—

The porous substrate is not particularly limited as long as it has a pore through which water and ions can permeate. It is preferable that the porous substrate has a large number of minute pores penetrating from a front surface to a back surface. For example, a porous substrate that can be used as a separator for water electrolysis can be used.

The porous substrate preferably includes a resin as a constituent material. As the constituent material of the porous substrate, for example, a hydrocarbon polymer (preferably a polyolefin, more preferably polyethylene, polypropylene, or the like), a fluoropolymer (polytetrafluoroethylene, or the like), polystyrene, cellulose, polyacrylonitrile, a ceramic, or the like can be used, and a hydrocarbon polymer is preferably used.

The porous substrate may be a substrate having a porous structure. For example, the porous substrate may be a membrane (porous membrane) in which a resin is formed into a film and stretched to form fine pores, may be a textile, or may be a nonwoven fabric.

In a case where the porous substrate is a porous membrane, the porous substrate may be manufactured by a dry method or may be manufactured by a wet method, and the porous substrate manufactured by the dry method is preferable. Here, the dry method is a method of forming a film from a melted resin, performing a heat treatment, and stretching the film to form fine pores, and the wet method is a method of melting a resin and a plasticizer (solvent), forming a film, stretching the film, and extracting the plasticizer to form fine pores.

In the present invention, the porous substrate is preferably a porous membrane made of polyethylene, a porous membrane made of polypropylene, a nonwoven fabric made of polyethylene, or a nonwoven fabric made of polytetrafluoroethylene, and more preferably a porous membrane made of polyethylene.

The thickness of the porous substrate only needs to be such that a hydroxide ion-conductive membrane having a thickness of 5 μm or more and less than 50 μm is obtained. Therefore, the thickness is preferably 5 μm or more and less than 50 μm, more preferably 6 μm or more and 40 μm or less, still more preferably 6 μm or more and 35 μm or less, even more preferably 7 μm or more and 30 μm or less, even still more preferably 7 μm or more and 25 μm or less, even still more preferably 7 μm or more and 20 μm or less, and particularly preferably 7 μm or more and 15 μm or less.

The thickness of the porous substrate is measured after drying the porous substrate.

The porosity of the porous substrate is preferably 20% to 80%, more preferably 25% to 70%, still more preferably 30% to 60%, even more preferably 35% to 60%, even still more preferably 37% to 55%, even still more preferably 38% to 50%, and particularly preferably 40% to 50%

The porosity can be obtained by calculation from an apparent volume and a theoretical volume, and specifically, can be obtained as follows.

### —Method of Calculating Porosity—

An apparent volume (volume of the entire porous substrate including a volume of a pore) of the porous substrate is defined as X (cm³), a weight of the porous substrate is defined as W (g), and a true density of the porous substrate is defined as d (g/cm³), and the porosity is calculated by the following numerical expression from X and a theoretical volume Y (cm³) (Y=W/d).

$$Porosity ( \% ) = [ 1 - ( Y / X ) ] \times 100$$

The tensile strength of the porous substrate is preferably 10 MPa or more, more preferably 20 MPa or more, and still more preferably 30 MPa or more. The tensile strength of the porous substrate is usually 400 MPa or less. Therefore, the tensile strength of the porous substrate is preferably 10 to 400 MPa, more preferably 20 to 400 MPa, and still more preferably 30 to 400 MPa.

The breaking elongation of the porous substrate is preferably 10% or more, more preferably 50% or more, and still more preferably 100% or more. The breaking elongation of the porous substrate is usually 500% or less. Therefore, the breaking elongation of the porous substrate is preferably 10% to 500%, more preferably 50% to 500%, and still more preferably 100% to 500%.

The tensile strength and the breaking elongation of the porous substrate can be measured in the same manner as the method of [Evaluation of mechanical properties] described in Examples, except that the porous substrate is used instead of the polymer membrane and the porous substrate is not water-swollen.

The porous substrate is preferably surface-modified. By the surface modification, a physical or chemical bonding state with the hydroxide ion-conductive polymer can be formed in a case of synthesizing the hydroxide ion-conductive polymer, and the adhesiveness between the hydroxide ion-conductive polymer and the porous substrate can be further increased. Examples of the method of the surface modification include a corona treatment or a plasma treatment.

The corona treatment and the plasma treatment can be performed by a normal method.

As the porous substrate, for example, “porous substrate film” and “laminate porous substrate film” described in paragraphs [0018] to [0023] of JP2018-127506A and “microporous membrane” described in paragraph [0022] of JP2022-181107 are also suitable.

The thickness of the hydroxide ion-conductive membrane is preferably 5 to 50 μm, more preferably 6 to 40 μm, still more preferably 6 to 35 μm, even more preferably 7 to 30 μm, even still more preferably 7 to 25 μm, even still more preferably 7 to 20 μm, and particularly preferably 7 to 15 μm. The thickness of the hydroxide ion-conductive membrane can be set to 5 to 100 μm, 10 to 100 μm, 20 to 80 μm, or 30 to 80 μm.

The thickness of the hydroxide ion-conductive membrane is measured at 10 randomly selected positions, and an arithmetic average of the 10 measured values is calculated. It is noted that the thickness of the porous substrate is also determined in the same manner as described above.

In a case where the hydroxide ion-conductive membrane is a composite body, the thickness of the hydroxide ion-conductive membrane may be the same as the thickness of the porous substrate or may be larger than the thickness of the porous substrate. The thickness of the hydroxide ion-conductive membrane may be the same as the thickness of the porous substrate in a case of synthesizing the hydroxide ion-conductive polymer, or may be a thickness of about 110% to 120% of the thickness of the porous substrate. In a case where the thickness of the hydroxide ion-conductive membrane is larger than the thickness of the porous substrate, the hydroxide ion-conductive polymer is introduced, as a polymer filling internal pores, in an amount greater than the void fraction (for example, more of the polymer is filled due to elongation (expansion) of the porous substrate, or the hydroxide ion-conductive polymer is provided also in a portion of the outer surface of the porous substrate).

The thickness of the hydroxide ion-conductive membrane is measured for the hydroxide ion-conductive membrane after drying to remove moisture.

### <Cathode Catalyst Layer>

The cathode catalyst layer can be a cathode catalyst layer that includes a cathode catalyst and a polymer and is used in a typical membrane electrode assembly.

The cathode catalyst can be selected depending on the application of the membrane electrode assembly according to the embodiment of the present invention.

In a case where the membrane electrode assembly according to the embodiment of the present invention is a membrane electrode assembly for an application of water electrolysis, the cathode catalyst only needs to electrolyze water to generate hydrogen (gas). As such a cathode catalyst, platinum-supported carbon particles, platinum-coated titanium, palladium-supported carbon particles, cobalt glyoxime, nickel glyoxime, or the like can be used.

In a case where the membrane electrode assembly according to the embodiment of the present invention is a membrane electrode assembly for an application of a fuel cell, the cathode catalyst only need to react with oxygen to generate water. As such a cathode catalyst, platinum-supported carbon particles, platinum-coated titanium, palladium-supported carbon particles, cobalt glyoxime, nickel glyoxime, or the like can be used.

The cathode catalyst is preferably particulate.

In the cathode catalyst layer, it is preferable that the particulate cathode catalyst is bound by the above-described polymer.

As the polymer contained in the cathode catalyst layer, for example, the polymer described as the hydroxide ion-conductive polymer can be used.

A concentration of the polymer contained in the cathode catalyst layer is not particularly limited.

In a case where the polymer contained in the cathode catalyst layer satisfies the relationships (Ri) and (Rii), a concentration of the polymer contained in the cathode catalyst layer is preferably 1% to 30% by mass, more preferably 1% to 25% by mass, still more preferably 3% to 25% by mass, even more preferably 5% to 25% by mass, and particularly preferably 10% to 20% by mass with respect to the solid content in the catalyst layer.

The cathode catalyst layer can be formed by producing an ink for forming a catalyst layer containing the cathode catalyst, a monomer from which the above-described polymer is derived, and a solvent as necessary, and applying and drying the ink.

### <Anode Catalyst Layer>

The anode catalyst layer can be an anode catalyst layer that can be used in a typical membrane electrode assembly, which contains an anode catalyst and a polymer.

The anode catalyst can be selected depending on the application of the membrane electrode assembly according to the embodiment of the present invention.

In a case where the membrane electrode assembly according to the embodiment of the present invention is a membrane electrode assembly for an application of water electrolysis, the anode catalyst only needs to be catalyst that generates oxygen in water electrolysis. As such an anode catalyst, it is possible to use an iridium oxide, iridium oxide-coated titanium, an iridium ruthenium cobalt oxide, an iridium ruthenium tin oxide, an iridium ruthenium iron oxide, an iridium ruthenium nickel oxide, an iridium tin oxide, an iridium zirconium oxide, a ruthenium titanium oxide, a ruthenium zirconium oxide, a ruthenium tantalum oxide, a ruthenium titanium cerium oxide, or the like.

In a case where the membrane electrode assembly according to the embodiment of the present invention is a membrane electrode assembly for an application of a fuel cell, the anode catalyst only need to react with hydrogen to generate protons. As such an anode catalyst, platinum, platinum-supported carbon, a nickel oxide, or the like can be used.

The anode catalyst is preferably particulate.

In the anode catalyst layer, it is preferable that the particulate cathode catalyst is bound by the above-described polymer.

As the polymer contained in the anode catalyst layer, for example, the polymer described as the hydroxide ion-conductive polymer can be used.

A concentration of the polymer contained in the anode catalyst layer is not particularly limited.

In a case where the polymer contained in the anode catalyst layer satisfies the relationships (Ri) and (Rii), a concentration of the polymer contained in the anode catalyst layer is preferably 1% to 30% by mass, more preferably 1% to 25% by mass, still more preferably 3% to 25% by mass, even more preferably 5% to 25% by mass, and even still more preferably 10% to 20% by mass with respect to the solid content in the catalyst layer.

The anode catalyst layer can be formed by producing an ink for forming a catalyst layer containing the anode catalyst, a monomer from which the above-described polymer is derived, and a solvent as necessary, and applying and drying the ink.

### <Gas Diffusion Layer>

The gas diffusion layer can be a layer capable of transporting gas and moisture and having electron conductivity.

The gas diffusion layer can be a gas diffusion layer used in a typical membrane electrode assembly.

As a constituent material of the gas diffusion layer, a carbon fiber nonwoven fabric, a carbon paper, a carbon plate, a stainless steel (SUS) fiber nonwoven fabric, a sintered stainless steel body, a titanium (Ti) fiber nonwoven fabric, a sintered titanium body, a nickel (Ni) fiber nonwoven fabric, a sintered nickel body, a material coated with platinum or gold on each of these substrates, or the like can be used.

The membrane electrode assembly can be formed by applying the ink for forming a catalyst layer to the hydroxide ion-conductive membrane, or bonding a pre-formed catalyst layer to the hydroxide ion-conductive membrane.

In a case where the gas diffusion layer is provided on the membrane electrode assembly, the ink for forming a catalyst layer may be applied to one surface side of the gas diffusion layer to form a gas diffusion layer with a catalyst layer, and the gas diffusion layer with a catalyst layer may be bonded to the hydroxide ion-conductive membrane.

The ion resistance of the membrane electrode assembly is preferably as low as possible. The ion resistance of the membrane electrode assembly is preferably 2 Ωcm² or less, more preferably 1 Ωcm² or less, and still more preferably 0.5 Ωcm² or less. The ion resistance is usually 0.01 Ωcm² or more. Therefore, the ion resistance is preferably 0.01 to 2 Ωcm², more preferably 0.01 to 1 Ωcm², and still more preferably 0.01 to 0.5 Ωcm².

The ion resistance Rs can be calculated from the ion conductivity σ of the membrane electrode assembly and the thickness L (cm) of the membrane electrode assembly by the following expression.

$$Ion resistance Rs ( {Ωcm}^{2} ) = thickness L ( cm ) of membrane electrode assembly / ion conductivity σ ( S / cm )$$

The ion conductivity σ of the membrane electrode assembly can be measured in the same manner as the ion conductivity of the hydroxide ion-conductive membrane.

The thickness L of the membrane electrode assembly is determined in the same manner as the thickness of the hydroxide ion-conductive membrane.

The difference in voltage of the hydroxide ion-conductive membrane, which is measured by the method described in Examples (“Resistance evaluation”) described later, is preferably 0.50 V or less, more preferably 0.30 V or less, and still more preferably 0.25 V or less. The difference in voltage is usually greater than 0.00 V. Therefore, the difference in voltage is preferably more than 0.00 V and 0.50 V or less, more preferably more than 0.00 V and 0.30 V or less, and still more preferably more than 0.00 V and 0.25 V or less.

The difference in voltage can be measured by the method described in Examples in a state where the hydroxide ion-conductive membrane is incorporated into the water electrolysis cell.

The hydrogen gas permeability (permeability of hydrogen gas generated on the cathode side to the anode side) of the membrane electrode assembly is preferably less than 1.000 vol % (less than 1% by volume), more preferably less than 0.800 vol %, still more preferably less than 0.500 vol %, and even more preferably less than 0.100 vol %. The hydrogen gas permeability is usually preferably 0.000 vol % (detection limit or less). Therefore, the gas permeability is preferably 0.000 to less than 1.000 vol %, more preferably 0.000 to less than 0.800 vol %, still more preferably 0.000 to less than 0.500 vol %, and even more preferably 0.000 to less than 0.100 vol %.

The gas permeability can be measured by the method described in Examples after the membrane electrode assembly is incorporated into the water electrolysis cell.

### [Method for Producing Hydrogen]

The method for producing hydrogen according to the embodiment of the present invention is the same as a typical method for producing hydrogen (water electrolysis) except that the membrane electrode assembly according to the embodiment of the present invention is used as a membrane electrode assembly.

Since the method for producing hydrogen according to the embodiment of the present invention can be a form in which the hydroxide ion conductivity of the membrane electrode assembly according to the embodiment of the present invention is high, in this case, water electrolysis can be performed not only using a high concentration of alkali aqueous solution but also using a lower concentration of alkali aqueous solution or water.

### [Hydrogen Production System]

The hydrogen production system according to the embodiment of the present invention is a suitable system (apparatus) for performing the method for producing hydrogen according to the embodiment of the present invention.

The hydrogen production system according to the embodiment of the present invention is the same as a typical hydrogen production system except that the membrane electrode assembly according to the embodiment of the present invention is included as the membrane electrode assembly.

The hydrogen production system according to the embodiment of the present invention can be, for example, a water electrolysis system in which the membrane electrode assembly according to the embodiment of the present invention is further combined with a constituent member generally used in water electrolysis, such as a bipolar plate.

### EXAMPLES

Hereinafter, the present invention will be described in more detail based on Examples; however, the present invention is not limited thereto be interpreted.

### Example 1

A membrane electrode assembly having the following members and a water electrolysis cell 101 including the membrane electrode assembly were produced as follows.

1. Production of Gas Diffusion Layer 1-a1G with Anode Catalyst Layer

### 1) Preparation of Ink A1 for Forming Anode Catalyst Layer

61.5 g of pure water, 18.5 g of isopropyl alcohol, 1.2 g of a monomer m1, and 2.8 g of a monomer m2 were charged into a 200 mL three-neck flask to prepare a solution. A mass ratio of the monomer m1 to the monomer m2 at this time was 30:70. In a yellow light, furthermore, 0.1 g of 2-hydroxy-2-methylpropiophenone (manufactured by Tokyo Chemical Industry Co., Ltd.) (hereinafter, also referred to as “HMP”) and 0.1 g of ethyl (2,4,6-trimethylbenzoyl)phenylphosphinate (manufactured by Tokyo Chemical Industry Co., Ltd.) (hereinafter, also referred to as “EPTBP”) were added thereto to prepare a solution a1.

In a yellow light, 0.84 g of the solution a1 and 0.23 g of an iridium oxide powder (manufactured by TANAKA PRECIOUS METAL GROUP Co., Ltd., TEC77100 (trade name), iridium content of 75% by mass) were charged into a 5 mL vial bottle and mixed. In a case of mixing, an ultrasonic homogenizer UH-300 (trade name, manufactured by SMT Co., Ltd.) was used and dispersion of the mixture at an output of 30 W for 2 minutes, cooling of the mixture at 5° C. for 10 minutes, and dispersion of the mixture again at an output of 30 W for 2 minutes (dispersion-cooling-dispersion cycle) were repeated three times. In this way, an ink a1 for forming an anode catalyst layer having a solids content of 25% by mass was prepared.

2) Production of Gas Diffusion Layer 1-a1G with Anode Catalyst Layer

In a yellow light, the ink a1 for forming an anode catalyst layer was applied to the microporous layer side of the carbon fiber nonwoven fabric (manufactured by SGL Carbon SE, GDL-39BB (trade name)) having a microporous layer using an applicator such that the amount of the iridium oxide applied was 0.5 mg/cm². After natural drying, the monomer was polymerized by irradiating with UV light using a UV irradiation apparatus (EXECURE 3000 (product name), manufactured by HOYA Corporation) adjusted to be 100 mJ/cm²·second at 365 nm such that the cumulative light amount was 800 mJ/cm². In this way, a gas diffusion layer 1-a1G with an anode catalyst layer having the anode catalyst layer 1-a1 having a thickness of 8 μm on the microporous layer was obtained.

2. Production of Gas Diffusion Layer 1-b1G with Cathode Catalyst Layer

### 1) Preparation of Ink b1 for Forming Cathode Catalyst Layer

58.1 g of pure water, 17.4 g of isopropyl alcohol, 1.2 g of a monomer m1, and 2.8 g of a monomer m2 were charged into a 200 mL three-neck flask to prepare a solution. A mass ratio of the monomer m1 to the monomer m2 at this time was 30:70. In a yellow light, furthermore, 0.1 g of HMP and 0.1 g of EPTBP were added thereto to prepare a solution b1.

In a yellow light, 0.8 g of the solution b1 and 0.09 g of a platinum carbon powder (manufactured by TANAKA PRECIOUS METAL GROUP Co., Ltd., TEC10E50E (trade name), platinum content of 47% by mass) were mixed in a 5 mL vial bottle. In a case of mixing, an ultrasonic homogenizer UH-300 (trade name, manufactured by SMT Co., Ltd.) was used and dispersion of the mixture at an output of 30 W for 2 minutes, cooling of the mixture at 5° C. for 10 minutes, and dispersion of the mixture again at an output of 30 W for 2 minutes (dispersion-cooling-dispersion cycle) were repeated three times. In this way, an ink b1 for forming a cathode catalyst layer having a solids content of 15% by mass was prepared.

2) Production of Gas Diffusion Layer 1-b1G with Cathode Catalyst Layer

In a yellow light, the ink b1 for forming a cathode catalyst layer was applied to the microporous layer side of the carbon fiber nonwoven fabric (manufactured by SGL Carbon SE, GDL-39BB (trade name)) having a microporous layer using an applicator such that the amount of the platinum carbon powder applied was 0.5 mg/cm². After natural drying, the monomer was polymerized by irradiating with UV light using a UV irradiation apparatus (EXECURE 3000 (product name), manufactured by HOYA Corporation) adjusted to be 100 mJ/cm²·second at 365 nm such that the cumulative light amount was 800 mJ/cm². In this way, a gas diffusion layer 1-b1G with a cathode catalyst layer having the cathode catalyst layer 1-b1 having a thickness of 20 μm on the microporous layer was obtained.

### 3. Production of Hydroxide Ion-Conductive Membrane 1-c1

### 1) Preparation of Monomer Composition c1

10.0 g of pure water, 3.0 g of isopropyl alcohol, 15.6 g of a monomer m1, and 36.4 g of a monomer m2 were charged into a 200 mL three-neck flask to prepare a solution. A mass ratio of the monomer m1 to the monomer m2 at this time was 30:70. In a yellow light, furthermore, 1.0 g of HMP and 1.0 g of EPTBP were added to prepare a monomer composition c1 having a solids content of 80% by mass.

### 2) Production of Hydroxide Ion-Conductive Membrane 1-c1

In a yellow light, an appropriate amount of the monomer composition c1 was placed on a polyethylene terephthalate (PET) film having a thickness of 10 μm, applied with an applicator, and naturally dried. The monomer was polymerized by irradiating with UV light using a UV irradiation apparatus (EXECURE 3000 (product name), manufactured by HOYA Corporation) adjusted to be 100 mJ/cm²·second at 365 nm such that the cumulative light amount was 300 mJ/cm². Next, the PET film was removed. In this way, a hydroxide ion-conductive membrane 1-c1 having a thickness of 50 μm was produced.

### 4. Production of Membrane Electrode Assembly D-1 and Water Electrolysis Cell 101

The gas diffusion layer 1-a1G with an anode catalyst layer and the gas diffusion layer 1-b1G with a cathode catalyst layer were each punched out to have an area of 1 cm² in the same shape, laminated to interpose the hydroxide ion-conductive membrane 1-c1 therebetween with the catalyst layer sides facing the inside, and pressurized at a surface pressure of 4 MPa. The pressurized laminate was sandwiched between two Ni-made bipolar plates having a flow path, and was restrained with bolts such that the restraint pressure was 1 MPa. In this way, a water electrolysis cell 101 having the same layer structure as the water electrolysis cell 10 having a layer structure of a bipolar plate-gas diffusion layer-anode catalyst layer-hydroxide ion-conductive membrane-cathode catalyst layer-gas diffusion layer-bipolar plate shown in FIG. 1 was obtained. The water electrolysis cell 101 has a structure including the membrane electrode assembly D-1 (anode catalyst layer-hydroxide ion-conductive membrane-cathode catalyst layer or gas diffusion layer-anode catalyst layer-hydroxide ion-conductive membrane-cathode catalyst layer-gas diffusion layer).

### Example 2

1. Production of Gas Diffusion Layer 2-a1G with Anode Catalyst Layer

A gas diffusion layer 2-a1G with an anode catalyst layer having the anode catalyst layer 2-a1 was obtained in the same manner as in “1. Production of gas diffusion layer 1-a1G with anode catalyst layer” of Example 1, except that, in “1. Production of gas diffusion layer 1-a1G with anode catalyst layer” of Example 1, 4.0 g of a monomer m3 (DENACOL EX-832 (trade name), manufactured by Nagase ChemteX Corporation) was used instead of the monomer m1 and the monomer m2, 0.4 g of diphenyl [4-(phenylthio)phenyl]sulfonium hexafluorophosphate (manufactured by Tokyo Chemical Industry Co., Ltd.) (hereinafter, also referred to as “DPPSH”) was used as a polymerization initiator instead of HMP and EPTBP, an ink for forming an anode catalyst layer having a solids content of 45% by mass was used, UV light was irradiated such that the cumulative light amount was 600 mJ/cm² during polymerization, and the mixture was further heated at 100° C. for 15 minutes.

2. Production of Gas Diffusion Layer 2-b1G with Cathode Catalyst Layer

A gas diffusion layer 2-b1G with a cathode catalyst layer having the cathode catalyst layer 2-b1 was obtained in the same manner as in “2. Production of gas diffusion layer 1-b1G with cathode catalyst layer” of Example 1, except that, in “2. Production of gas diffusion layer 1-b1G with cathode catalyst layer” of Example 1, 4.0 g of a monomer m3 was used instead of the monomer m1 and the monomer m2, 0.4 g of DPPSH was used as a polymerization initiator instead of HMP and EPTBP, an ink for forming a cathode catalyst layer having a solids content of 35% by mass was used, UV light was irradiated such that the cumulative light amount was 600 mJ/cm² during polymerization, and the mixture was further heated at 100° C. for 15 minutes.

### 3. Production of Hydroxide Ion-Conductive Membrane 2-c1

72.0 g of the monomer m3 was charged into a 200 mL three-neck flask to prepare a solution. In a yellow light, furthermore, 2.0 g of DPPSH was added thereto as a polymerization initiator to prepare a monomer composition c2 having a solids content of 100% by mass.

In a yellow light, an appropriate amount of the monomer composition c2 was placed on a polyethylene terephthalate (PET) film having a thickness of 10 μm, applied with an applicator, and naturally dried. The monomer was polymerized by irradiating with UV light using a UV irradiation apparatus (EXECURE 3000 (product name), manufactured by HOYA Corporation) adjusted to be 100 mJ/cm²·second at 365 nm such that the cumulative light amount was 300 mJ/cm² and further heating at 80° C. for 5 minutes. Next, the PET film was removed. In this way, a hydroxide ion-conductive membrane 2-c1 was produced.

### 4. Production of Membrane Electrode Assembly D-2 and Water Electrolysis Cell 102

A membrane electrode assembly D-2 and a water electrolysis cell 102 were produced in the same manner as in “4. Production of membrane electrode assembly D-1 and water electrolysis cell 101” of Example 1, except that the gas diffusion layer 2-a1G with an anode catalyst layer, the gas diffusion layer 2-b1G with a cathode catalyst layer, and the hydroxide ion-conductive membrane 2-c1 were used.

### Example 3

A membrane electrode assembly D-3 and a water electrolysis cell 103 were produced in the same manner as in “4. Production of membrane electrode assembly D-1 and water electrolysis cell 101” of Example 1, except that in “4. Production of membrane electrode assembly D-1 and water electrolysis cell 101” of Example 1, the hydroxide ion-conductive membrane 2-c1 of Example 2 was used instead of the hydroxide ion-conductive membrane 1-c1.

### Example 4

A gas diffusion layer 4-a1G with an anode catalyst layer having the anode catalyst layer 4-a1 was obtained in the same manner as in “1. Production of gas diffusion layer 1-a1G with anode catalyst layer” of Example 1, except that in “1. Production of gas diffusion layer 1-a1G with anode catalyst layer” of Example 1, the blending amount of the solution a1 and the blending amount of the iridium oxide were changed to satisfy each of the “monomer amount” and the “catalyst amount” described in Table 1.

A membrane electrode assembly D-4 and a water electrolysis cell 104 were produced in the same manner as in “4. Production of membrane electrode assembly D-1 and water electrolysis cell 101” of Example 1, except that in “4. Production of membrane electrode assembly D-1 and water electrolysis cell 101” of Example 1, the gas diffusion layer 4-a1G with an anode catalyst layer was used instead of the gas diffusion layer 1-a1G with an anode catalyst layer.

### Example 5

A gas diffusion layer 5-a1G with an anode catalyst layer having the anode catalyst layer 5-a1 was obtained in the same manner as in “1. Production of gas diffusion layer 1-a1G with anode catalyst layer” of Example 1, except that in “1. Production of gas diffusion layer 1-a1G with anode catalyst layer” of Example 1, the blending amount of the solution a1 and the blending amount of the iridium oxide were changed to satisfy each of the “monomer amount” and the “catalyst amount” described in Table 1.

A gas diffusion layer 5-b1G with a cathode catalyst layer having the cathode catalyst layer 5-b1 was obtained in the same manner as in “2. Production of gas diffusion layer 1-b1G with cathode catalyst layer” of Example 1, except that in “2. Production of gas diffusion layer 1-b1G with cathode catalyst layer” of Example 1, the blending amount of the solution b1 and the blending amount of the platinum carbon powder were changed to satisfy each of the “monomer amount” and the “catalyst amount” described in Table 1.

A membrane electrode assembly D-5 and a water electrolysis cell 105 were produced in the same manner as in “4. Production of membrane electrode assembly D-1 and water electrolysis cell 101” of Example 1, except that in “4. Production of membrane electrode assembly D-1 and water electrolysis cell 101” of Example 1, the gas diffusion layer 5-a1G with an anode catalyst layer was used instead of the gas diffusion layer 1-a1G with an anode catalyst layer and the gas diffusion layer 5-b1G with a cathode catalyst layer was used instead of the gas diffusion layer 1-b1G with a cathode catalyst layer.

### Example 6

A gas diffusion layer 6-b1G with a cathode catalyst layer having the cathode catalyst layer 6-b1 was obtained in the same manner as in “2. Production of gas diffusion layer 2-b1G with cathode catalyst layer” of Example 2, except that in “2. Production of gas diffusion layer 2-b1G with cathode catalyst layer” of Example 2, polymerization was performed by irradiating UV light such that the cumulative light amount was 300 mJ/cm² and heating at 80° C. for 5 minutes.

A membrane electrode assembly D-6 and a water electrolysis cell 106 were produced in the same manner as in “4. Production of membrane electrode assembly D-1 and water electrolysis cell 101” of Example 1, except that in “4. Production of membrane electrode assembly D-1 and water electrolysis cell 101” of Example 1, the gas diffusion layer 6-b1G with a cathode catalyst layer was used instead of the gas diffusion layer 1-b1G with a cathode catalyst layer.

### Example 7

A gas diffusion layer 7-a1G with an anode catalyst layer having the anode catalyst layer 7-a1 was obtained in the same manner as in “1. Production of gas diffusion layer 2-a1G with anode catalyst layer” of Example 2, except that in “1. Production of gas diffusion layer 2-a1G with anode catalyst layer” of Example 2, UV light was irradiated such that the cumulative light amount was 300 mJ/cm², and the mixture was further heated at 80° C. for 5 minutes during polymerization.

A membrane electrode assembly D-7 and a water electrolysis cell 107 were produced in the same manner as in “4. Production of membrane electrode assembly D-1 and water electrolysis cell 101” of Example 1, except that in “4. Production of membrane electrode assembly D-1 and water electrolysis cell 101” of Example 1, the gas diffusion layer 7-a1G with an anode catalyst layer was used instead of the gas diffusion layer 1-a1G with an anode catalyst layer.

### Comparative Example 1

A hydroxide ion-conductive membrane x1-c1 was produced in the same manner as in “3. Production of hydroxide ion-conductive membrane 1-c1” of Example 1, except that in “3. Production of hydroxide ion-conductive membrane 1-c1” of Example 1, polymerization was performed by irradiating UV light such that the cumulative light amount was 800 mJ/cm².

A membrane electrode assembly D-c1 and a water electrolysis cell c101 were produced in the same manner as in “4. Production of membrane electrode assembly D-1 and water electrolysis cell 101” of Example 1, except that in “4. Production of membrane electrode assembly D-1 and water electrolysis cell 101” of Example 1, the hydroxide ion-conductive membrane x1-c1 was used instead of the hydroxide ion-conductive membrane 1-c1.

### Comparative Example 2

A gas diffusion layer x1-a1G with an anode catalyst layer x1-a1 was produced in the same manner as in “1. Production of gas diffusion layer 1-a1G with anode catalyst layer” of Example 1, except that in “1. Production of gas diffusion layer 1-a1G with anode catalyst layer” of Example 1, polymerization was performed by irradiating UV light such that the cumulative light amount was 300 mJ/cm².

A gas diffusion layer x1-b1G with a cathode catalyst layer having the cathode catalyst layer x1-b1 was produced in the same manner as in “2. Production of gas diffusion layer 1-b1G with cathode catalyst layer” of Example 1, except that in “2. Production of gas diffusion layer 1-b1G with cathode catalyst layer” of Example 1, polymerization was performed by irradiating UV light such that the cumulative light amount was 300 mJ/cm².

A membrane electrode assembly D-c2 and a water electrolysis cell c102 were produced in the same manner as in “4. Production of membrane electrode assembly D-1 and water electrolysis cell 101” of Example 1, except that in “4. Production of membrane electrode assembly D-1 and water electrolysis cell 101” of Example 1, the gas diffusion layer x1-a1G with an anode catalyst layer and the gas diffusion layer x1-b1G with a cathode catalyst layer were used instead of the gas diffusion layer 1-a1G with an anode catalyst layer and the gas diffusion layer 1-b1G with a cathode catalyst layer.

### Comparative Example 3

A gas diffusion layer x3-a1G with an anode catalyst layer having the anode catalyst layer x3-a1 was obtained in the same manner as in “1. Production of gas diffusion layer 2-a1G with anode catalyst layer” of Example 2, except that in “1. Production of gas diffusion layer 2-a1G with anode catalyst layer” of Example 2, 3.6 g of the monomer m3 and 0.4 g of a monomer m4 (DENACOL EX-861 (trade name), manufactured by Nagase ChemteX Corporation) (mass ratio of the monomer m3 to the monomer m4 was 90:10) were used.

A gas diffusion layer x3-b1G with a cathode catalyst layer having the cathode catalyst layer x3-b1 was obtained in the same manner as in “2. Production of gas diffusion layer 2-b1G with cathode catalyst layer” of Example 2, except that in “2. Production of gas diffusion layer 2-b1G with cathode catalyst layer” of Example 2, 3.6 g of the monomer m3 and 0.4 g of the monomer m4 (mass ratio of the monomer m3 to the monomer m4 was 90:10) were used.

A hydroxide ion-conductive membrane x3-c1 was produced in the same manner as in “3. Production of hydroxide ion-conductive membrane 2-c1” of Example 2, except that in “3. Production of hydroxide ion-conductive membrane 2-c1” of Example 2, UV light was irradiated such that the cumulative light amount was 600 mJ/cm² and the mixture was further heated at 100° C. for 15 minutes during polymerization.

A membrane electrode assembly D-c3 and a water electrolysis cell c103 were produced in the same manner as in “4. Production of membrane electrode assembly D-1 and water electrolysis cell 101” of Example 1, except that in “4. Production of membrane electrode assembly D-1 and water electrolysis cell 101” of Example 1, the gas diffusion layer x3-a1G with an anode catalyst layer, the gas diffusion layer x3-b1G with a cathode catalyst layer, and the hydroxide ion-conductive membrane x3-c1 were used instead of the gas diffusion layer 1-a1G with an anode catalyst layer, the gas diffusion layer 1-b1G with a cathode catalyst layer, and the hydroxide ion-conductive membrane 1-c1.

### Comparative Example 4

A hydroxide ion-conductive membrane x4-c1 was produced in the same manner as in “3. Production of hydroxide ion-conductive membrane 2-c1” of Example 2, except that in “3. Production of hydroxide ion-conductive membrane 2-c1” of Example 2, 64.8 g of the monomer m3 and 7.2 g of the monomer m4 (mass ratio of the monomer m3 to the monomer m4 was 90:10) were used, UV light was irradiated such that the cumulative light amount was 600 mJ/cm², and the mixture was further heated at 100° C. for 15 minutes during polymerization.

A membrane electrode assembly D-c4 and a water electrolysis cell c104 were produced in the same manner as in “4. Production of membrane electrode assembly D-2 and water electrolysis cell 102” of Example 2, except that in “4. Production of membrane electrode assembly D-2 and water electrolysis cell 102” of Example 2, the hydroxide ion-conductive membrane x4-c1 was used instead of the hydroxide ion-conductive membrane 2-c1.

In all of the hydroxide ion-conductive membranes obtained as described above, the ion conductivity was 0.1 mS/cm to 10 S/cm.

Table 1 below summarizes materials used for the preparation of the membrane electrode assembly and the water electrolysis cell, the blending amounts of each component, and the polymerization conditions.

In addition, structures of monomers used below are shown.

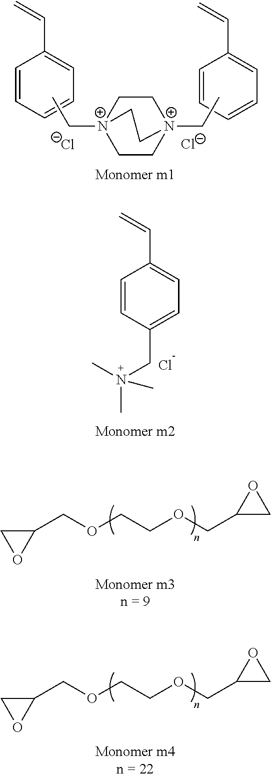

### [Evaluation of Mechanical Properties]

The tensile strength (a) and the breaking elongation (b) of the water-swollen body of the polymer contained in the cathode catalyst layer and the anode catalyst layer, and the tensile strength (c) and the breaking elongation (d) of the water-swollen body of the hydroxide ion-conductive polymer constituting the hydroxide ion-conductive membrane were measured as follows.

For the measurement of the tensile strength and the breaking elongation, a motorized test stand MX-500N and a force gauge ZTA series (both trade names, manufactured by IMADA Co., Ltd.) were used.

The membrane of the polymer single body of the polymer contained in the cathode catalyst layer and the anode catalyst layer, and the hydroxide ion-conductive polymer constituting the hydroxide ion-conductive membrane was prepared as follows.

The dissolved polymer obtained by dissolving the polymer from each layer and filtering was applied onto a substrate and dried to obtain a membrane of the polymer single body. In a case where it is difficult to form the membrane of the polymer single body, the following can be performed. In a case of the polymer contained in the cathode catalyst layer and the anode catalyst layer, a membrane of the polymer single body can be obtained by synthesizing the polymer without adding the anode catalyst or the cathode catalyst. In addition, in a case of the hydroxide ion-conductive polymer constituting the hydroxide ion-conductive membrane, a membrane of the polymer single body can be obtained by synthesizing the polymer without using the porous substrate.

In a case where the hydroxide ion-conductive membrane has a form of a membrane (single membrane) formed of the hydroxide ion-conductive polymer without including the porous substrate, the membrane can be used as it is.

The membrane of the polymer single body obtained as described above was cut into a strip shape of 5 mm×15 mm to obtain a test piece.

The test piece was immersed in water at room temperature (25° C.) for one day and one night such that the entire test piece was immersed to obtain a water-swollen test piece.

Two parallel lines were drawn at the center portion of the obtained test piece at an interval of 5 mm, and both ends of the test piece were clamped and pulled at a speed of 0.5 mm/min. The maximum tensile stress at this time was defined as the tensile strength. The breaking elongation was calculated by the following expression. In this way, the tensile strength and the breaking elongation were measured.

$$Breaking elongation ( \% ) = 100 \times ( L - {L}_{0} ) / {L}_{0}$$

L₀: distance between lines before test, L: distance between lines at break

Table 2 below shows the tensile strength and the breaking elongation of each polymer.

As shown in Table 1, in the formation of the anode catalyst layer 1-a1, the cathode catalyst layer 1-b1, the anode catalyst layer 4-a1, the anode catalyst layer 5-a1, the cathode catalyst layer 5-b1, and the hydroxide ion-conductive membrane x1-c1, since the types of monomers used and the amount used thereof are the same and the monomers are exposed and polymerized under the same exposure conditions, the polymers contained in the anode catalyst layer 1-a1, the cathode catalyst layer 1-b1, the anode catalyst layer 4-a1, the anode catalyst layer 5-a1, the cathode catalyst layer 5-b1, and the hydroxide ion-conductive membrane x1-c1 are substantially the same as each other. Similarly, the polymers contained in the anode catalyst layer 2-a1, the cathode catalyst layer 2-b1, and the hydroxide ion-conductive membrane x3-c1 are also substantially the same as each other, the polymers contained in the anode catalyst layer x1-a1, the cathode catalyst layer x1-b1, and the hydroxide ion-conductive membrane 1-c1 are also substantially the same as each other, the polymers contained in the anode catalyst layer 7-a1, the cathode catalyst layer 6-b1, and the hydroxide ion-conductive membrane 2-c1 are also substantially the same as each other, and the polymers contained in the anode catalyst layer x3-a1, the cathode catalyst layer x3-b1, and the hydroxide ion-conductive membrane x4-c1 are also substantially the same as each other. Accordingly, in the “Polymer” column of Table 1, the polymers obtained were denoted by Nos. P1 to P5, and Table 2 collectively shows the tensile strength, the breaking elongation, the glass transition temperature, and the molecular weight of each polymer.

### [Measurement of Glass Transition Temperature]

The glass transition temperature (e) of the polymer contained in the cathode catalyst layer and the anode catalyst layer and the glass transition temperature (f) of the hydroxide ion-conductive membrane-forming polymer were measured according to the above-described method.

### [Measurement of Molecular Weight]

The molecular weight of the hydroxide ion-conductive polymer was measured according to the above-described method.

### [Evaluation of Water Electrolysis Cell]

While supplying a 0.5 M potassium hydroxide (KOH) aqueous solution heated to 60° C. at a flow rate of 10 mL/min to each of the cathode catalyst layer and the anode catalyst layer of each water electrolysis cell obtained above, the cells were energized at current density of 0.1 A/cm² for 4 hours, thereby obtaining water electrolysis cells after initial energization. Various evaluations described later were performed using these water electrolysis cells after initial energization.

### <Resistance Evaluation>

The initial voltage (V0) of each water electrolysis cell immediately after the initial energization (energization at 0.1 A/cm² for 4 hours) and the voltage (V1) immediately after energizing each water electrolysis cell at 1.0 A/cm² for 10 minutes while supplying a 0.2 M KOH aqueous solution heated to 60° C. were measured. V1-V0 was obtained from the obtained measurement values as the difference in voltage.

The obtained difference in voltage was applied to the following evaluation standard to evaluate the resistance. The higher the difference in voltage, the higher the resistance.

### —Evaluation Standard of Difference in Voltage—

A: more than 0.00 V and 0.25 V or less
B: more than 0.25 V and 0.30 V or less
C: more than 0.30 V and 0.50 V or less
D: more than 0.50 V

### <Evaluation of Hydrogen Gas Permeability>

Each water electrolysis cell after the initial energization was energized at 0.1 A/cm² for 10 minutes while supplying a 0.2 M KOH aqueous solution heated to 60° C., and the gas collected from the flow path of the bipolar plate on the anode side was analyzed to evaluate the degree to which the hydrogen gas generated on the cathode side permeated to the anode side.

Specifically, the gas collected from the flow path of the bipolar plate on the anode side during the 10 minutes of energization was cooled at 10° C., water vapor was removed, then the collected gas was passed through the gas chromatograph (GC3210G (trade name), manufactured by GL Sciences Inc., column: MS13X (trade name)), and the ratio (vol %) of the hydrogen gas contained in the collected gas was measured.

The obtained ratio of the hydrogen gas was applied to the following evaluation standard to perform evaluation.

### —Evaluation Standard of Hydrogen Gas Permeability (Ratio of Hydrogen Gas)—

A: less than 0.100 vol %
B: 0.100 vol % or more and less than 0.500 vol %
C: 0.500 vol % or more and less than 1.000 vol %
D: 1.000 vol % or more

### <Evaluation of Repeated Energization Durability>

Each water electrolysis cell after the initial energization was energized at 0.1 A/cm² for 1 hour while supplying a 0.2 M KOH aqueous solution heated to 60° C., and then the liquid supply and the energization were stopped and the water electrolysis cell was left for 3 hours. This was defined as one cycle, and energization and stop were repeated for 500 cycles.

The voltage after 1 cycle and the voltage after 500 cycles were measured, and the rate of change in voltage was obtained.

The obtained rate of change in voltage was applied to the following evaluation standard to evaluate the repeated energization durability.

$$Rate of change in voltage = [ \text{} ( voltage after 500 cycles - voltage after 1 cycle ) \text{} / voltage after 1 cycle ] \times 100 ( \% )$$

### —Evaluation Standard of Repeated Energization Durability—

A: 0.05% or less
B: more than 0.05% and 1.00% or less
C: more than 1.00% and 2.00% or less
D: more than 2.00% and 4.00% or less
E: more than 4.00%

TABLE 1

| | | | | Monomer 1 | | Monomer 2 | | Monomer amount | Polymerization | Type of | Catalyst amount | Solids content | Polymerization | Polymerization | |
|---|---|---|---|---|---|---|---|---|---|---|---|---|---|---|---|
| | | Site | Name | Type | % by mass | Type | % by mass | Parts by mass | initiator | catalyst | Parts by mass | % by mass | method | condition | Polymer |
| Example | 1 | Anode | 1-a1 | m1 | 30 | m2 | 70 | 15 | HMP | IrO₂ | 85 | 25 | UV | 800 mJ/cm² | P1 |
| | | catalyst layer | | | | | | | EPTBP | | | | | | |
| | | Cathode | 1-b1 | m1 | 30 | m2 | 70 | 30 | HMP | Pt/C | 70 | 15 | UV | 800 mJ/cm² | P1 |
| | | catalyst layer | | | | | | | EPTBP | | | | | | |
| | | Conductive | 1-c1 | m1 | 30 | m2 | 70 | 100 | HMP | — | — | 80 | UV | 300 mJ/cm² | P2 |
| | | membrane | | | | | | | EPTBP | | | | | | |
| | 2 | Anode | 2-a1 | m3 | 100 | — | 0 | 15 | DPPSH | IrO₂ | 85 | 45 | UV + Heat | 600 mJ/cm² | P3 |
| | | catalyst layer | | | | | | | | | | | | 100° C. 15 min | |
| | | Cathode | 2-b1 | m3 | 100 | — | 0 | 30 | DPPSH | Pt/C | 70 | 35 | UV + Heat | 600 mJ/cm² | P3 |
| | | catalyst layer | | | | | | | | | | | | 100° C. 15 min | |
| | | Conductive | 2-c1 | m3 | 100 | — | 0 | 100 | DPPSH | — | — | 100 | UV + Heat | 300 mJ/cm² | P4 |
| | | membrane | | | | | | | | | | | | 80° C. 5 min | |
| | 3 | Anode | 1-a1 | m1 | 30 | m2 | 70 | 15 | HMP | IrO₂ | 85 | 25 | UV | 800 mJ/cm² | P1 |
| | | catalyst layer | | | | | | | EPTBP | | | | | | |
| | | Cathode | 1-b1 | m1 | 30 | m2 | 70 | 30 | HMP | Pt/C | 70 | 15 | UV | 800 mJ/cm² | P1 |
| | | catalyst layer | | | | | | | EPTBP | | | | | | |
| | | Conductive | 2-c1 | m3 | 100 | — | 0 | 100 | DPPSH | — | — | 100 | UV + Heat | 300 mJ/cm² | P4 |
| | | membrane | | | | | | | | | | | | 80° C. 5 min | |
| | 4 | Anode | 4-a1 | m1 | 30 | m2 | 70 | 30 | HMP | IrO₂ | 70 | 25 | UV | 800 mJ/cm² | P1 |
| | | catalyst layer | | | | | | | EPTBP | | | | | | |
| | | Cathode | 1-b1 | m1 | 30 | m2 | 70 | 30 | HMP | Pt/C | 70 | 15 | UV | 800 mJ/cm² | P1 |
| | | catalyst layer | | | | | | | EPTBP | | | | | | |
| | | Conductive | 1-c1 | m1 | 30 | m2 | 70 | 100 | HMP | — | — | 80 | UV | 300 mJ/cm² | P2 |
| | | membrane | | | | | | | EPTBP | | | | | | |
| Example | 5 | Anode | 5-a1 | m1 | 30 | m2 | 70 | 1 | HMP | IrO₂ | 99 | 25 | UV | 800 mJ/cm² | P1 |
| | | catalyst layer | | | | | | | EPTBP | | | | | | |
| | | Cathode | 5-b1 | m1 | 30 | m2 | 70 | 1 | HIMP | Pt/C | 99 | 15 | UV | 800 mJ/cm² | P1 |
| | | catalyst layer | | | | | | | EPTBP | | | | | | |
| | | Conductive | 1-c1 | m1 | 30 | m2 | 70 | 100 | HMP | — | — | 80 | UV | 300 mJ/cm² | P2 |
| | | membrane | | | | | | | EPTBP | | | | | | |
| | 6 | Anode | 1-a1 | m1 | 30 | m2 | 70 | 15 | HMP | IrO₂ | 85 | 25 | UV | 800 mJ/cm² | P1 |
| | | catalyst layer | | | | | | | EPTBP | | | | | | |
| | | Cathode | 6-b1 | m3 | 100 | — | 0 | 30 | DPPSH | Pt/C | 70 | 35 | UV + Heat | 300 mJ/cm² | P4 |
| | | catalyst layer | | | | | | | | | | | | 80° C. 5 min | |
| | | Conductive | 1-c1 | m1 | 30 | m2 | 70 | 100 | HMP | — | — | 80 | UV | 300 mJ/cm² | P2 |
| | | membrane | | | | | | | EPTBP | | | | | | |
| | 7 | Anode | 7-a1 | m3 | 100 | — | 0 | 15 | DPPSH | IrO₂ | 85 | 45 | UV + Heat | 300 mJ/cm² | P4 |
| | | catalyst layer | | | | | | | | | | | | 80° C. 5 min | |
| | | Cathode | 1-b1 | m1 | 30 | m2 | 70 | 30 | HMP | Pt/C | 70 | 15 | UV | 800 mJ/cm² | P1 |
| | | catalyst layer | | | | | | | EPTBP | | | | | | |
| | | Conductive | 1-c1 | m1 | 30 | m2 | 70 | 100 | HMP | — | — | 80 | UV | 300 mJ/cm² | P2 |
| | | membrane | | | | | | | EPTBP | | | | | | |
| Comparative | 1 | Anode catalyst | 1-a1 | m1 | 30 | m2 | 70 | 15 | HMP | IrO₂ | 85 | 25 | UV | 800 mJ/cm² | P1 |
| Example | | layer | | | | | | | EPTBP | | | | | | |
| | | Cathode | 1-b1 | m1 | 30 | m2 | 70 | 30 | HMP | Pt/C | 70 | 15 | UV | 800 mJ/cm² | P1 |
| | | catalyst layer | | | | | | | EPTBP | | | | | | |
| | | Conductive | x1-c1 | m1 | 30 | m2 | 70 | 100 | HMP | — | — | 80 | UV | 800 mJ/cm² | P1 |
| | | membrane | | | | | | | EPTBP | | | | | | |
| | 2 | Anode catalyst | x1-a1 | m1 | 30 | m2 | 70 | 15 | HMP | IrO₂ | 85 | 25 | UV | 300 mJ/cm² | P2 |
| | | laver | | | | | | | EPTBP | | | | | | |
| | | Cathode | x1-b1 | m1 | 30 | m2 | 70 | 30 | HMP | Pt/C | 70 | 15 | UV | 300 mJ/cm² | P2 |
| | | catalyst layer | | | | | | | EPTBP | | | | | | |
| | | Conductive | 1-c1 | m1 | 30 | m2 | 70 | 100 | HMP | — | — | 80 | UV | 300 mJ/cm² | P2 |
| | | membrane | | | | | | | EPTBP | | | | | | |
| | 3 | Anode catalyst | x3-a1 | m3 | 90 | m4 | 10 | 15 | DPPSH | IrO₂ | 85 | 45 | UV + Heat | 600 mJ/cm² | P5 |
| | | layer | | | | | | | | | | | | 100° C. 15 min | |
| | | Cathode | x3-b1 | m3 | 90 | m4 | 10 | 30 | DPPSH | Pr/C | 70 | 35 | UV + Heat | 600 mJ/cm² | P5 |
| | | catalyst layer | | | | | | | | | | | | 100° C. 15 min | |
| | | Conductive | x3-c1 | m3 | 100 | — | 0 | 100 | DPPSH | — | — | 100 | UV + Heat | 600 mJ/cm² | P3 |
| | | membrane | | | | | | | | | | | | 100° C. 15 min | |
| | 4 | Anode catalyst | 2-a1 | m3 | 100 | — | 0 | 15 | DPPSH | IrO₂ | 85 | 45 | UV + Heat | 600 mJ/cm² | P3 |
| | | laver | | | | | | | | | | | | 100° C. 15 min | |
| | | Cathode | 2-b1 | m3 | 100 | — | 0 | 30 | DPPSH | Pt/C | 70 | 35 | UV + Heat | 600 mJ/cm² | P3 |
| | | catalyst layer | | | | | | | | | | | | 100° C. 15 min | |
| | | Conductive | x4-c1 | m3 | 90 | m4 | 10 | 100 | DPPSH | — | — | 100 | UV + Heat | 600 mJ/cm² | P5 |
| | | membrane | | | | | | | | | | | | 100° C. 15 min | |

<Note in Table 1>
“—”: indicates that the component was not used.
“% by mass” in monomer 1 and monomer 2: indicates, in the formation of each catalyst layer, a proportion (% by mass) of each monomer in 100% by mass of all polymerizable monomers contained in the ink. In the formation of the hydroxide ion-conductive membrane, a proportion (% by mass) of each monomer in 100% by mass of all polymerizable monomers contained in the monomer composition is indicated.
“Parts by mass” in monomer amount: an amount of all polymerizable monomers (parts by mass) in a case where the total amount of all polymerizable monomers and the catalyst is 100 parts by mass. Therefore, in the formation of the hydroxide ion-conductive membrane, the monomer amount is 100 parts by mass. “Parts by mass” in monomer amount is % by mass of the polymer contained in each of the cathode catalyst layer, the anode catalyst layer, and the hydroxide ion-conductive membrane.
“Parts by mass” in catalyst amount: an amount of catalyst (parts by mass) in a case where the total amount of all polymerizable monomers and the catalyst is 100 parts by mass.
HMP: 2-hydroxy-2-methylpropiophenone
EPTBP: ethyl (2,4,6-trimethylbenzoyl)phenylphosphinate
DPPSH: diphenyl[4-(phenylthio)phenyl]sulfonium hexafluorophosphate
IrO₂: iridium oxide
Pt/C: platinum carbon powder
“Solids content”: for each catalyst layer, indicates a content of solid content contained in the ink. For the hydroxide ion-conductive membrane, a content of the solid content contained in the monomer composition is shown.
Polymerization method: “UV” in a case where the polymerization of the monomer was performed by UV exposure, and “Heat” in a case where the polymerization of the monomer was performed by heating.
Polymerization conditions: conditions of UV exposure or heating are described. In a case where both the UV exposure and the heating were performed, the UV exposure conditions are described in the upper part, and the heating conditions are described in the lower part.

Table 2 shows the characteristics of each polymer.

TABLE 2

| | Tensile | Breaking | Glass transition | |
|---|---|---|---|---|
| Polymer | strength | elongation | temperature | Molecular |
| No. | MPa | % | ° C. | weight |
| P1 | 40 | 30 | 100 | 10000 |
| P2 | 12 | 10 | 60 | 5000 |
| P3 | 30 | 50 | −70 | 2500 |
| P4 | 10 | 20 | −90 | 1200 |
| P5 | 20 | 70 | −85 | 3000 |

Table 3 shows the evaluation results of the membrane electrode assembly and the water electrolysis cell.

TABLE 3

| | | Water | Membrane electrode assembly | | | | | | | | | | | |
|---|---|---|---|---|---|---|---|---|---|---|---|---|---|---|
| | | electrol- | | Anode | | Hydroxide | | Cathode | | | | Evaluation | | |
| | | ysis | | catalyst | | ion-conductive | | catalyst | | | | Gas | | Repeated |
| | | cell | | layer | | membrane | | layer | | | | perme- | Resis- | energization |
| | | No. | No. | No. | Polymer | No. | Polymer | No. | Polymer | (Ri) | (Rii) | ability | tance | durability |
| Example | 1 | 101 | D-1 | 1-a1 | P1 | 1-c1 | P2 | 1-b1 | P1 | (a) > (c) | (b) > (d) | B | B | A |
| | 2 | 102 | D-2 | 2-a1 | P3 | 2-c1 | P4 | 2-b1 | P3 | (a) > (c) | (b) > (d) | A | A | A |
| | 3 | 103 | D-3 | 1-a1 | P1 | 2-c1 | P4 | 1-b1 | P1 | (a) > (c) | (b) > (d) | B | C | A |
| | 4 | 104 | D-4 | 4-a1 | P1 | 1-c1 | P2 | 1-b1 | P1 | (a) > (c) | (b) > (d) | A | C | A |
| | 5 | 105 | D-5 | 5-a1 | P1 | 1-c1 | P2 | 5-b1 | P1 | (a) > (c) | (b) > (d) | C | A | C |
| | 6 | 106 | D-6 | 1-a1 | P1 | 1-c1 | P2 | 6-b1 | P4 | (a) > (c)* | (b) > (d) | C | B | C |
| | 7 | 107 | D-7 | 7-a1 | P4 | 1-c1 | P2 | 1-b1 | P1 | (a) > (c)** | (b) > (d) | B | B | C |
| Comparative | 1 | c101 | D-c1 | 1-a3 | P1 | x1-c1 | P1 | 1-b1 | P1 | (a) = (c) | (b) = (d) | D | C | D |
| Example | 2 | c102 | D-c2 | x1-a1 | P2 | 1-c1 | P2 | x1-b1 | P2 | (a) = (c) | (b) = (d) | B | C | D |
| | 3 | c103 | D-c3 | x3-a1 | P5 | x3-c1 | P3 | x3-b1 | P5 | (a) < (c) | (b) > (d) | D | B | D |
| | 4 | c104 | D-c4 | 2-a1 | P3 | x4-c1 | P5 | 2-b1 | P3 | (a) > (c) | (b) < (d) | C | C | E |

<Note in Table 3>
(Ri): *indicates that only the combination of the polymer contained in the anode catalyst layer and the hydroxide ion-conductive membrane-forming polymer satisfies the relationship of (Ri).
(Ri): **indicates that only the combination of the polymer contained in the cathode catalyst layer and the hydroxide ion-conductive membrane-forming polymer satisfies the relationship of (Ri).

In the membrane electrode assemblies of Comparative Examples 1 and 2, the same hydroxide ion-conductive polymer was used as the polymer contained in the cathode catalyst layer, the polymer contained in the anode catalyst layer, and the hydroxide ion-conductive membrane-forming polymer, and the relationships of (Ri) and (Rii) were not satisfied. In a case where these membrane electrode assemblies were used as a water electrolysis cell, the rate of change in voltage in the repeated energization durability test exceeded 2.00%, and the repeated durability was poor. In addition, in the membrane electrode assembly of Comparative Example 1, the ratio of the hydrogen gas contained in the collected chain gas from the anode side was 1.000 vol % or more, and the gas permeability was also poor (high).

In the membrane electrode assemblies of Comparative Examples 3 and 4, the polymer contained in the cathode catalyst layer and the hydroxide ion-conductive membrane-forming polymer, and the polymer contained in the anode catalyst layer and the hydroxide ion-conductive membrane-forming polymer satisfied only one of the relationship of (Ri) or the relationship of (Rii). In the membrane electrode assembly of Comparative Example 3, which satisfies the relationship of (Rii) but does not satisfy the relationship of (Ri), the ratio of the hydrogen gas contained in the collected chain gas from the anode side was 1.000 vol % or more, and the gas permeability was poor (high). In addition, in a case where the membrane electrode assembly was used as a water electrolysis cell, the rate of change in voltage in the repeated energization durability test exceeded 2.00%, and the repeated durability was poor. On the other hand, in the membrane electrode assembly of Comparative Example 4, which satisfies the relationship of (Ri) but does not satisfy the relationship of (Rii), the rate of change in voltage in the repeated energization durability test exceeded 4.00% in a case where the membrane electrode assembly was used as a water electrolysis cell, and the repeated durability was poor.

On the other hand, in the membrane electrode assemblies of Examples 1 to 7, the polymer contained in the cathode catalyst layer and the hydroxide ion-conductive membrane-forming polymer, and/or the polymer contained in the anode catalyst layer and the hydroxide ion-conductive membrane-forming polymer satisfied the relationships of (Ri) and (Rii). In a case where these membrane electrode assemblies were used as a water electrolysis cell, the ratio of the hydrogen gas was less than 1.000 vol %, the difference in voltage was 0.50 V or less, the rate of change in the repeated energization test was 2% or less, and the gas permeability and the resistance were low, and the repeated energization durability was excellent.

The membrane electrode assembly of Example 2 is an example in which a hydroxide ion-conductive polymer having a different skeleton from the hydroxide ion-conductive polymer used in Example 1 was used. It can be seen that, even in a case where the type of the hydroxide ion-conductive polymer is changed, the membrane electrode assembly having low gas permeability and low resistance and excellent repeated energization durability can be obtained by satisfying the relationships of (Ri) and (Rii). It is considered that the peeling at the interface between the hydroxide ion-conductive membrane and the anode catalyst layer and/or the cathode catalyst layer due to the swelling and shrinking of the hydroxide ion-conductive membrane is suppressed.

In the membrane electrode assemblies of Examples 1 to 3, the absolute values of the difference between the glass transition temperature of the polymer contained in the anode catalyst layer and the cathode catalyst layer and the glass transition temperature of the hydroxide ion-conductive membrane-forming polymer are 40° C., 20° C., and 190° C., and the membrane electrode assemblies of Examples 1 and 2 have more excellent resistance than the membrane electrode assembly of Example 3. It can be seen that there is a tendency that the resistance can be reduced in a case where the absolute value of the difference is in a range of 1° C. to 50° C.

In the membrane electrode assembly of Example 1, the polymer contained in the anode catalyst layer was contained at a concentration of 15% by mass in the catalyst layer, whereas in the membrane electrode assemblies of Examples 4 and 5, the polymer contained in the anode catalyst layer was 30% by mass and 1% by mass. It can be seen that, since the membrane electrode assembly of Example 1 has no items that are evaluated as the evaluation standard C in each evaluation, there is a tendency that each characteristic can be well-balanced in a case where the amount of the polymer contained in each catalyst layer is set to 5% to 25% by mass.

Although the present invention has been described with reference to the embodiments, it is the intention of the inventors of the present invention that the present invention should not be limited by any of the details of the description unless otherwise specified and rather be construed broadly within the spirit and scope of the invention appended in the claims.

The present application claims the priority of JP2023-161730A filed in Japan on Sep. 25, 2023, the contents of which are incorporated herein by reference, as a part of the description of the present specification.

### EXPLANATION OF REFERENCES

1: hydroxide ion-conductive membrane
   2a: anode catalyst layer
      21: anode catalyst
      23: ionomer resin
   2c: cathode catalyst layer
      22: cathode catalyst
      23: ionomer resin
   3: gas diffusion layer
   4: membrane electrode assembly
   5: bipolar plate
   10: water electrolysis cell

What is claimed is:

1. A membrane electrode assembly having a structure in which a cathode catalyst layer, a hydroxide ion-conductive membrane, and an anode catalyst layer are laminated in this order,
wherein a tensile strength (a) and a breaking elongation (b) of a water-swollen body of a polymer contained in the cathode catalyst layer and/or the anode catalyst layer and a tensile strength (c) and a breaking elongation (d) of a water-swollen body of a hydroxide ion-conductive polymer constituting the hydroxide ion-conductive membrane satisfy the following relationships (Ri) and (Rii),
$$t ensile strength ( a ) > tensile strength ( c ) , \qquad ( Ri )$$
$$b reaking elongation ( b ) > breaking elongation ( d ) . \qquad ( Rii )$$

2. The membrane electrode assembly according to claim 1,
wherein an absolute value of a difference between a glass transition temperature (e) of the polymer that is contained in the cathode catalyst layer and/or the anode catalyst layer and satisfies the relationships (Ri) and (Rii), and a glass transition temperature (f) of the hydroxide ion-conductive polymer is 1° C. to 190° C.

3. The membrane electrode assembly according to claim 2,
wherein the polymer that is contained in the cathode catalyst layer and/or the anode catalyst layer and satisfies the relationships (Ri) and (Rii) is contained in a catalyst layer containing the polymer at a concentration of 5% to 25% by mass.

4. The membrane electrode assembly according to claim 3,
wherein at least the polymer contained in the cathode catalyst layer satisfies the relationships (Ri) and (Rii).

5. The membrane electrode assembly according to claim 4,
wherein the polymer contained in the anode catalyst layer satisfies the relationships (Ri) and (Rii).

6. The membrane electrode assembly according to claim 5,
wherein a molecular weight of the polymer contained in the cathode catalyst layer and the anode catalyst layer is larger than a molecular weight of the hydroxide ion-conductive polymer.

7. A method for producing hydrogen using the membrane electrode assembly according to claim 1.

8. A hydrogen production system comprising:
the membrane electrode assembly according to claim 1.
